(19) United States
(12) Patent Application Publication
(10) Pub. No.: US 2022/0190426 A1
(43) Pub. Date: Jun. 16, 2022

(54) MODULAR BATTERY ASSEMBLY FOR BATTERY POWERED EQUIPMENT

(71) Applicant: Briggs & Stratton Corporation, Wauwatosa, WI (US)

(72) Inventors: Jeffrey Zeiler, Brookfield, WI (US); Kyle Harvey, Wauwatosa, WI (US); Bryan Keith Dandridge, Wauwatosa, WI (US); Ryan Hahn, Wauwatosa, WI (US); Ryan Jaskowiak, Mukwonago, WI (US); Nick Zeidler, Wauwatosa, WI (US); Jacob Schmalz, Wauwatosa, WI (US); Mark Noller, Wauwatosa, WI (US); Todd Johnson, Wauwatosa, WI (US)

(21) Appl. No.: 17/598,812

(22) PCT Filed: Mar. 26, 2020
(86) PCT No.: PCT/US2020/024981

§ 371 Date: Sep. 27, 2021

Related U.S. Application Data
(60) Provisional application No. 62/825,367, filed on Mar. 28, 2019.

(51) Int. Cl. H01M 50/247; H01M 50/256; H01M 50/242; H01M 50/262; H01M 50/296

(52) U.S. Cl. CPC H01M 50/247; H01M 50/256; H01M 50/242; H01M 50/213; H01M 50/296; H01M 2220/30; H01M 50/262

(57) ABSTRACT

A power system for power equipment includes a battery having a capacity of at least 300-Watt hours and including a battery housing substantially enclosing the battery and a receiver including electrical terminals provided on the receiver, the electrical terminals selectively and electrically coupled to the battery. The receiver is configured to selectively couple with a portion of the battery housing. The receiver is configured to be decoupled from the portion of the battery housing without the use of tools. The receiver includes a planar mounting surface including at least one aperture for receiving a threaded fastener. The receiver is coupled to the power equipment via a threaded fastener.

### CROSS-REFERENCE TO RELATED APPLICATIONS

This application claims the benefit of U.S. Provisional Application No. 62/825,367, filed Mar. 28, 2019, which is incorporated herein by reference in its entirety.

### BACKGROUND

The present invention generally relates to the field of indoor and outdoor power equipment, and in particular, to the field of battery powered indoor and outdoor power equipment.

### SUMMARY

One embodiment of the disclosure includes a power system for power equipment. The power equipment includes a battery having a capacity of at least 300 Watt-hours. The battery also includes a battery housing substantially enclosing the battery. The power equipment includes a receiver including electrical terminals provided on the receiver, the electrical terminals selectively and electrically coupled to the battery. The receiver is configured to selectively couple with a portion of the battery housing. The receiver is configured to be decoupled from the portion of the battery housing without the use of tools. The receiver includes a planar mounting surface including at least one aperture for receiving a threaded fastener. The receiver is coupled to the power equipment via a threaded fastener

Another embodiment of the disclosure is a battery assembly including a housing, a handle, multiple battery cells, and a mating feature. The housing includes a first portion, a second portion, and a third portion connecting the first portion to the second portion. The second portion is located opposite the first portion. The handle is located above the first portion. The multiple battery cells are disposed within the housing. The mating feature includes multiple ports electrically connected to the plurality of battery cells. The mating feature is configured to supply power from the multiple battery cells through the ports. The mating feature is configured to selectively connect the battery assembly with a receptacle of at least one of a power equipment and a charging station. The mating feature is located on the first portion of the housing.

Another embodiment of the disclosure is a battery assembly including a housing, multiple battery cells, and a mating feature. The housing includes a handle. The multiple battery cells are disposed within the housing. The mating feature includes multiple ports electrically connected to the multiple battery cells. The mating feature is configured to supply power from the multiple battery cells through the ports. The mating feature is configured to selectively connect the battery assembly with a receptacle of at least one of a piece of power equipment and a charging station. The handle includes a release mechanism configured to selectively disengage the battery assembly from at least one of the piece of power equipment and the charging station when the release mechanism is in a released position. The housing includes multiple channels configured to interface with multiple protrusions of the receptacle.

Another embodiment of the disclosure is a battery assembly including a housing, multiple battery cells, and a mating feature. The housing includes a handle. The multiple battery cells are disposed within the housing. The mating feature includes multiple ports electrically connected to the multiple battery cells. The mating feature is configured to supply power from the multiple battery cells through the ports. The mating feature is configured to selectively connect the battery assembly with a receptacle of at least one of a piece of power equipment and a charging station. The handle includes a release mechanism configured to selectively disengage the battery assembly from at least one of the piece of power equipment and the charging station when the release mechanism is in a released position. The housing includes multiple channels configured to interface with multiple protrusions of the receptacle.

Another embodiment of the disclosure is a battery charging system including a charging station and multiple battery assemblies. The charging station includes multiple receptacles. Each of the battery assemblies includes a housing having a handle, multiple battery cells disposed within the housing, and a mating feature integrally formed with the housing. The mating feature is configured to selectively couple the battery assembly with the receptacle of the charging station and includes multiple ports electrically connected to multiple battery cells. The mating feature is configured to receive power from the charging station to charge the multiple battery cells. The handle includes a release mechanism configured to selectively disengage the battery assembly from multiple receptacles of the charging station.

Another embodiment of the disclosure is a battery assembly including a battery pack having a battery pack housing and a cell assembly positioned within the battery pack housing. The cell assembly includes multiple battery cells, a first collector plate, and a second collector plate. The multiple battery cells are electrically coupled together by the first collector plate and the second collector plate. The multiple battery cells are positioned between the first collector plate and the second collector plate. Multiple bushings are positioned between the battery pack housing and the first collector plate. Multiple bushings are also positioned between the battery pack housing and the second collector plate.

Alternative exemplary embodiments relate to other features and combinations of features as may be generally recited in the claims.

### BRIEF DESCRIPTION OF THE DRAWINGS

The disclosure will become more fully understood from the following detailed description, taken in conjunction with the accompanying figures, in which:

FIG. 1A is a perspective view of a battery assembly for use with various types of indoor and outdoor power equipment, according to an exemplary embodiment;

FIG. 1B is a perspective view of a battery assembly for use with various types of indoor and outdoor equipment, according to an exemplary embodiment;

FIG. 2A is a front view of the battery assembly of FIG. 1A;

FIG. 2B is a front view of the battery assembly of FIG. 1B;

FIG. 3A is a perspective view of a portion of the battery assembly of FIG. 1A;

FIG. 3B is a perspective view of a portions of the battery assembly of FIG. 1B;

FIG. 4 is a perspective view of the battery system of FIG. 1A;

FIG. 5 is a front view of the battery assembly of FIG. 1A;

FIG. 6 is a perspective view of a portion of the battery assembly of FIG. 1A;

FIG. 7 is a perspective exploded view of the battery system of FIG. 1A;

FIG. 8 is a perspective section view of the battery system of FIG. 1A;

FIG. 9 is a perspective view of a battery pack of the battery system of FIG. 1A;

FIG. 10 is a front view of the battery pack of FIG. 1A;

FIG. 11 is a perspective view of a portion of the battery pack of FIG. 9;

FIG. 12 is a perspective exploded view of the battery pack of FIG. 9;

FIG. 13 is a perspective view of a cell assembly of the battery pack of FIG. 9;

FIG. 14 is a top view of the cell assembly of FIG. 13;

FIG. 15 is a perspective view of the cell assembly of FIG. 13;

FIG. 16 is a perspective exploded view of the cell assembly of FIG. 13;

FIG. 17 is a perspective exploded view of the battery assembly of FIG. 1A;

FIG. 18A is a front view of the components of the battery assembly of FIG. 1A;

FIG. 18B is a perspective section view of the battery assembly of FIG. 1A;

FIG. 18C is a front section view of the battery assembly of FIG. 1A;

FIG. 19 is a perspective view of the battery assembly of FIG. 1A in use with a portable charger, according to an exemplary embodiment;

FIG. 20 is a perspective view of the portable charger of FIG. 19;

FIG. 21 is a perspective view of the battery assembly of FIG. 1A in use with a portable charger, according to an exemplary embodiment;

FIG. 22 is a perspective view of the portable charger of FIG. 21;

FIG. 23 is a perspective view of the battery pack of FIG. 9 with a power connector;

FIG. 24A is a perspective view of a multiple battery assembly stored in a vehicle;

FIG. 24B is a perspective view of a multiple battery assembly used as backup power in a home or business;

FIG. 25 is a schematic view of a battery and fleet management system, according to an exemplary embodiment;

FIG. 26 is a perspective view of a compact charger for use with the battery assembly of FIG. 1A, according to an exemplary embodiment;

FIG. 27 is a perspective view of the compact charger of FIG. 26 in use with the battery assembly of FIG. 1A, according to an exemplary embodiment;

FIG. 28 is a perspective view of the compact charger of FIG. 26;

FIG. 29 is a schematic view of an environment in which the compact charger of FIG. 26 is used;

FIG. 30 is a perspective view of a fast charger for use with the battery assembly of FIG. 1A, according to an exemplary embodiment;

FIG. 31 is a perspective view of the fast charger of FIG. 30 in use with the battery assembly of FIG. 1A, according to an exemplary embodiment;

FIG. 32 is a perspective view of the fast charger of FIG. 30 in use with the battery assembly of FIG. 1A, according to an exemplary embodiment;

FIG. 33 is a schematic view of an environment in which the fast charger of FIG. 30 is used;

FIG. 34 is a perspective view of a triple bay charger for use with multiple battery assemblies of FIG. 1A, according to an exemplary embodiment;

FIG. 35 is a perspective view of a triple bay charger of FIG. 34 in use with multiple battery assemblies of FIG. 1A, according to an exemplary embodiment; and

FIG. 36 is a schematic view of an environment in which the triple bay charger of FIG. 34 is used.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring to figures generally, the battery assembly described herein is a removable and replaceable battery assembly, which can be used with various types of indoor and outdoor power equipment, as well as with portable jobsite equipment. Outdoor power equipment includes lawn mowers, riding tractors, snow throwers, pressure washers, tillers, log splitters, zero-turn radius mowers, walk-behind mowers, riding mowers, stand-on mowers, pavement surface preparation devices, industrial vehicles such as forklifts, utility vehicles, commercial turf equipment such as blowers, vacuums, debris loaders, overseeders, power rakes, aerators, sod cutters, brush mowers, portable generators, etc. Indoor power equipment includes floor sanders, floor buffers and polishers, vacuums, etc. Portable jobsite equipment includes portable light towers, mobile industrial heaters, and portable light stands.

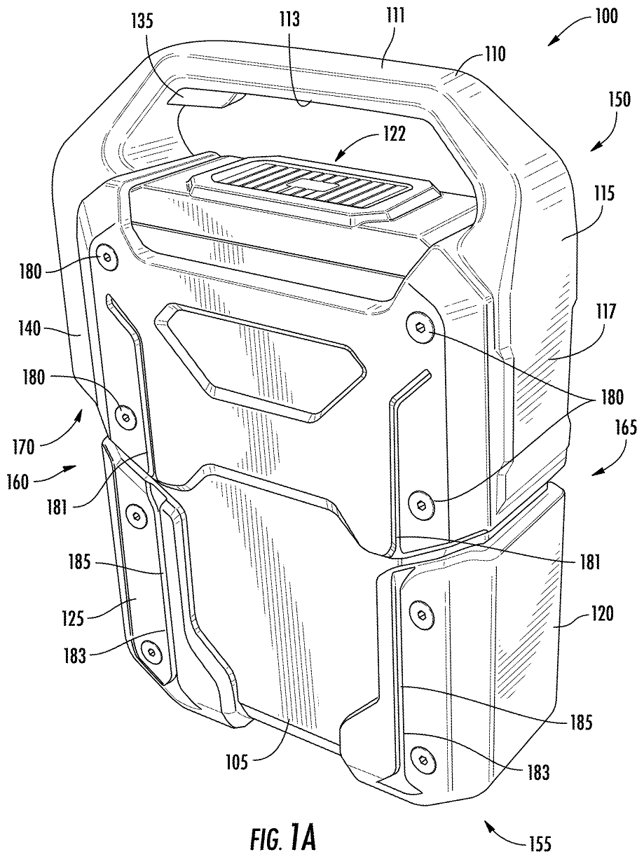

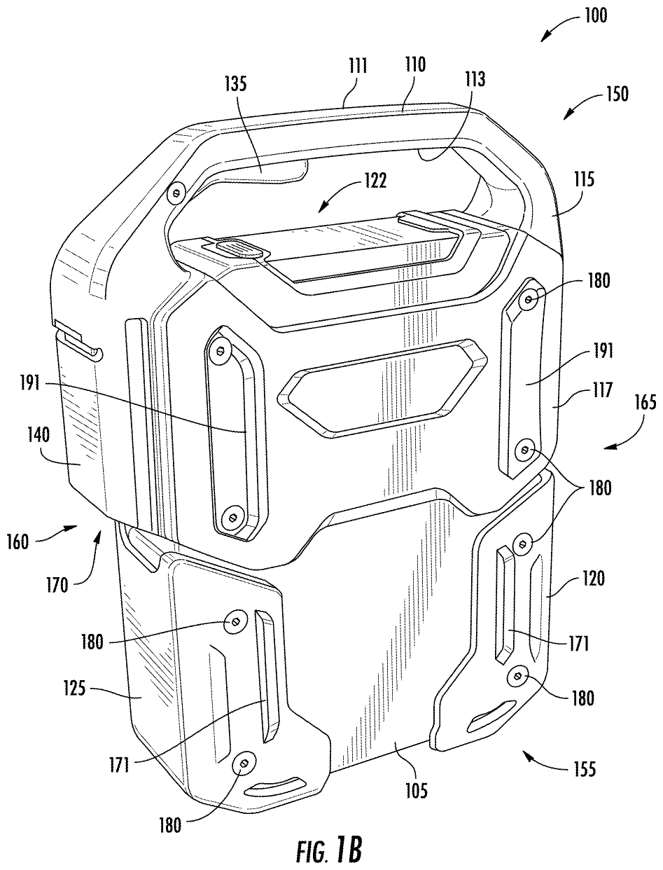

Referring to FIGS. 1A-1B, the battery assembly 100 is shown, according to an exemplary embodiment. The battery assembly 100 is removable and rechargeable. The battery assembly 100 is configured to be inserted (e.g., dropped, lowered, placed) into a receiver integrated with a piece of equipment and/or a charging station. The battery assembly 100 can be installed into a piece of equipment vertically, horizontally, and at any angle. The battery assembly 100 includes a battery pack 105 and optionally, one or more modular portions as described below. The battery pack 105 is a Lithium-ion battery. However, other battery types are contemplated, such as nickel-cadmium (NiCD), lead-acid, nickel-metal hydride (NiMH), lithium polymer, etc. The battery assembly 100 yields a voltage of approximately 48 Volts (V) and 1400 Watt-hours (Wh) of energy. It is contemplated that battery assemblies of other sizes may also be used. The battery assembly 100 may have a capacity of at least 300 Wh. The battery assembly 100 in total weighs less than approximately twenty pounds, allowing for ease of portability, removal, and replacement. The battery assembly 100 is also hot-swappable meaning that a drained battery assembly 100 can be exchanged for a new battery assembly 100 without completely powering down connected equipment. As such, downtime between battery assembly 100 exchanges is eliminated.

The battery assembly 100 can be removed by an operator from a piece of equipment (e.g., from a receiver of a piece of equipment) without the use of tools and recharged using a charging station, as described further herein. In this way, the operator may use a second rechargeable battery having a sufficient charge to power equipment while allowing the first battery to recharge. In addition, the battery assembly 100 can be used on various types of equipment including indoor, outdoor, and portable jobsite equipment. Due to its uniformity across equipment, the battery assembly 100 can also be used as part of a rental system, where rental companies who traditionally rent out pieces of equipment can also rent the battery assembly 100 to be used on such equipment. An operator can rent a battery assembly 100 to use on various types of equipment the operator may own and/or rent and then return the battery assembly 100 to be used by other operators on an as-needed basis. Furthermore, multiple battery assemblies 100 may be used in conjunction with each other to provide sufficient power to equipment that may require more than a single battery assembly.

The battery assembly 100 is configured to be selectively and electrically coupled to a piece of equipment and/or a charging station. The piece of equipment or charging station includes a receiver having electrical terminals that are selectively and electrically coupled to the battery assembly 100 without the use of tools. For example, an operator may both insert (and electrically couple) and remove (and electrically decouple) the battery assembly 100 from a piece of equipment (e.g., from terminals of a receiver) without the use of tools. The receiver may include a planar mounting surface having at least one aperture for receiving a threaded fastener and the receiver may be coupled to the piece of equipment via a threaded fastener.

Still referring to FIGS. 1A-1B, the battery pack 105 includes an upper portion 150, a lower portion 155, a left side 160, and a right side 165. The battery assembly 100 further includes an upper modular portion 115 coupled to the upper portion 150 of the battery pack 105, and lower modular portions 120, 125 coupled to a lower portion 155 of the battery pack 105 on each of the left and right sides 160, 165. The upper modular portion 115 and lower modular portions 120, 125 are coupled to the battery pack 105 using fasteners 180 (e.g., bolts, screws). The lower modular portions 120, 125 provide protection to the battery pack 105 and act to absorb or limit the amount of force the battery pack 105 endures by dropping, etc. In some embodiments, the battery assembly 100 may not include the upper modular portion 115 and/or lower modular portions 120, 125 and may be permanently mounted to a piece of equipment. The upper modular portion 115 and lower modular portions 120, 125 are exchangeable and customizable such that an operator or original equipment manufacturer may chose a different design and/or color based on the type or make and model of the equipment with which the battery assembly 100 is to be used. The upper modular portion 115 including the handle 110 and the lower modular portions 120, 125 can be removed from the battery pack 105. The upper modular portion, handle 110, and lower modular portions 120, 125 are coupled to the battery pack 105 using a mechanical interface and do not include any electrical connections. In this way, the battery pack 105 can be used without the modular portions and handle 110 or the modular portions and handle could be chosen specifically by an original equipment manufacturer to create their own unique platform.

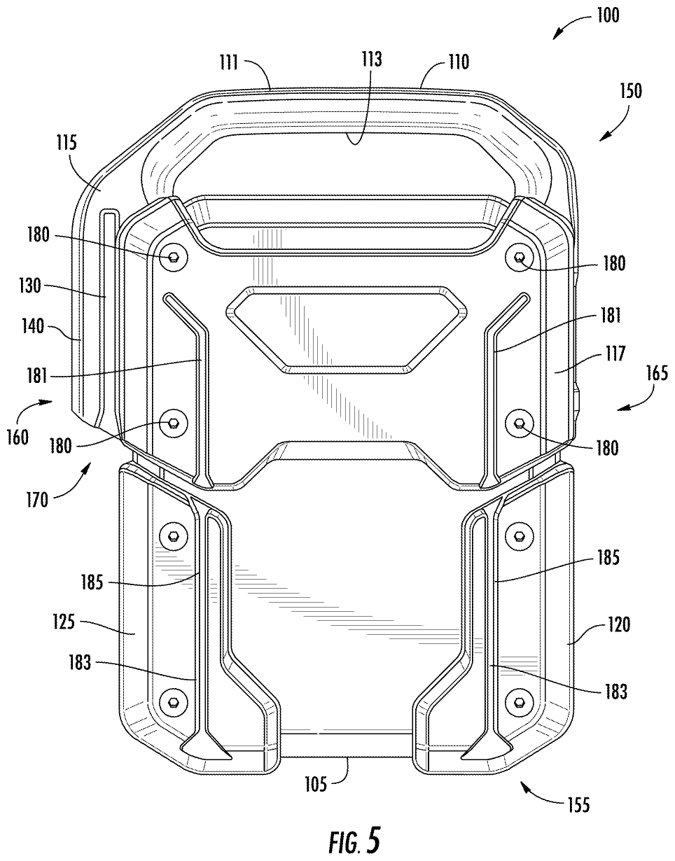

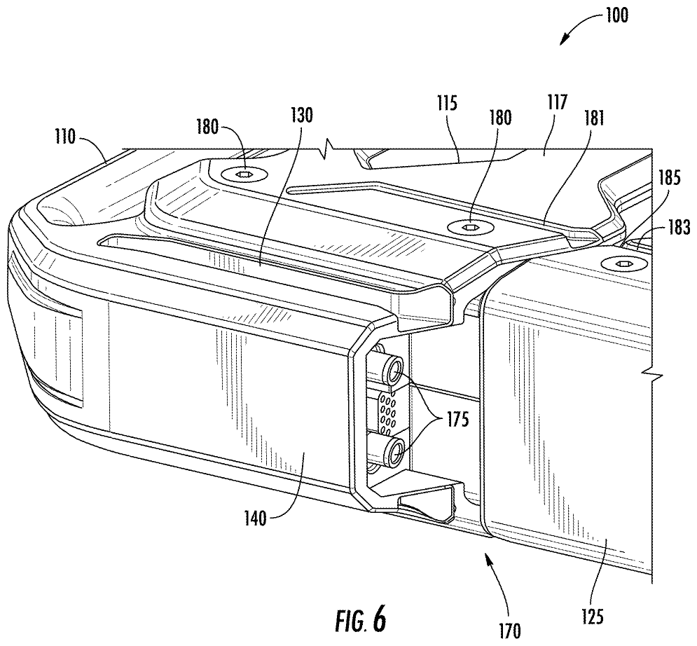

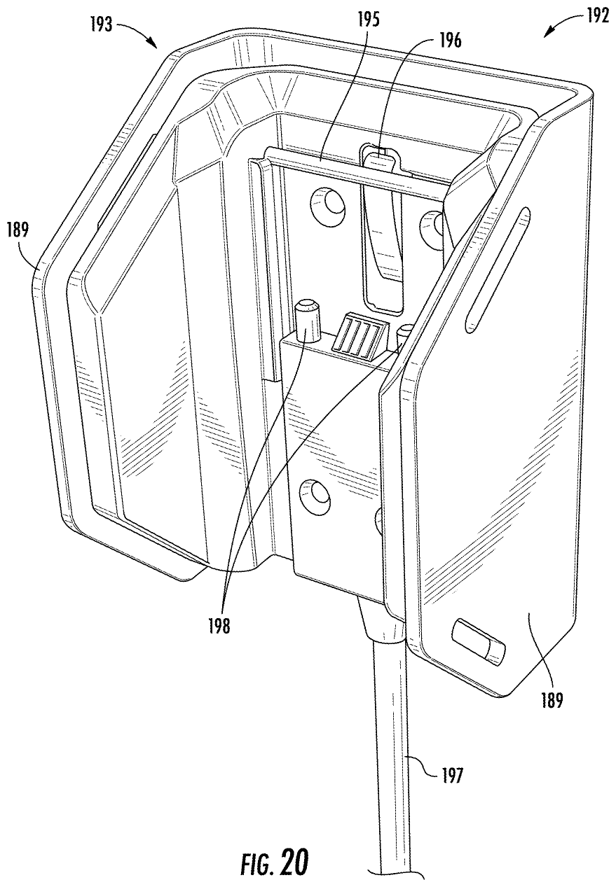

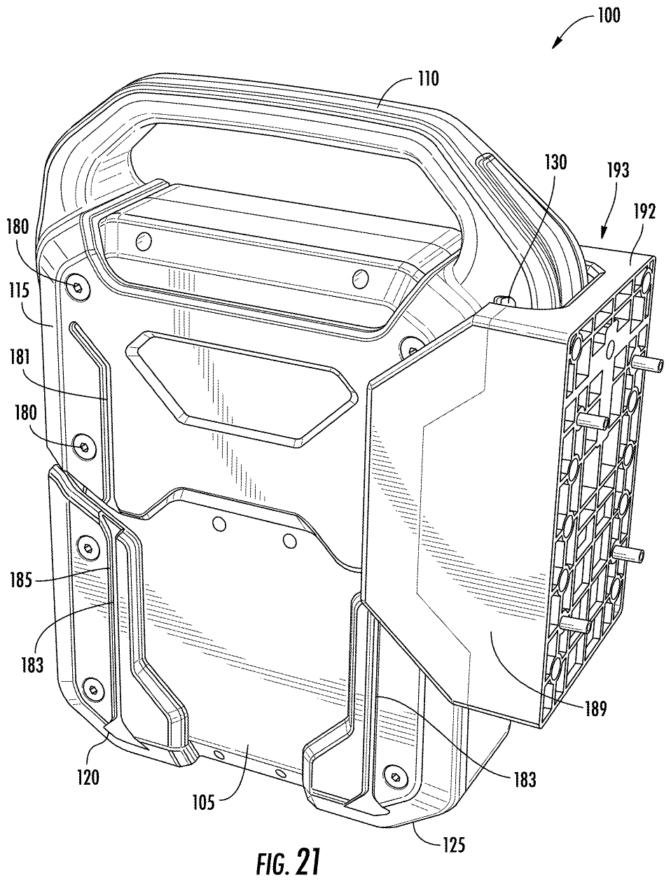

Referring to FIGS. 1A-5, the upper modular portion 115 includes a casing 117 and a handle 110 extending therefrom. The casing 117 surrounds the upper portion 150 of the battery pack 105. The casing 117 includes a mating portion 140 positioned proximate the left side 160 of the battery pack 105. The mating portion 140 includes an opening 170 having one or more ports 175 (FIG. 6) positioned therein. The ports 175 are configured to mate with charging connectors (e.g., charging connectors 198 in FIG. 20, 22) on a charger (e.g., charger 192 in FIGS. 20-22). The upper modular portion 115 includes an upper module portion slot 130 positioned on the mating portion 140 and configured to guide a respective feature on a charger onto the battery assembly 100 and/or a piece of equipment.

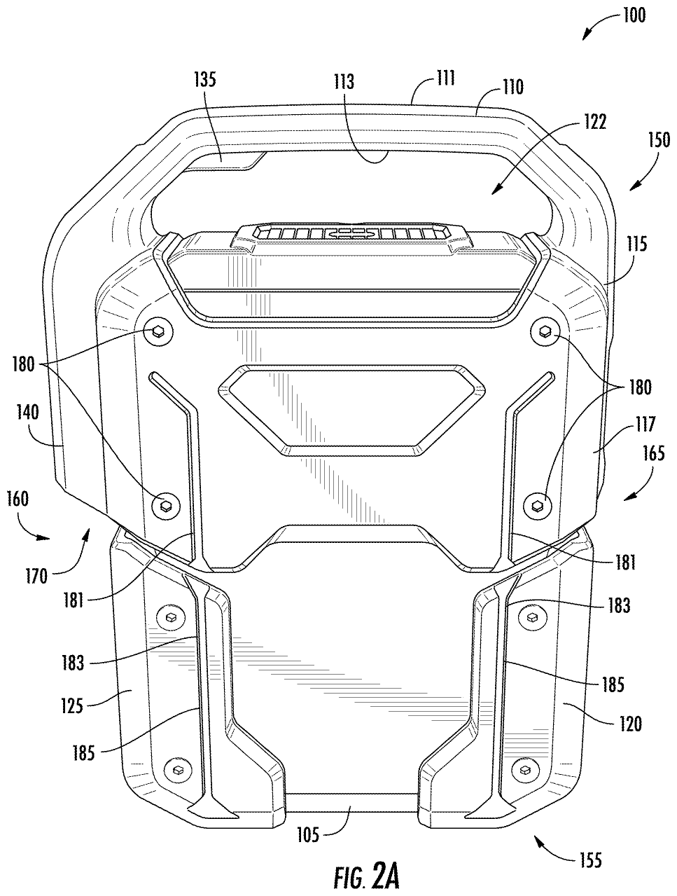

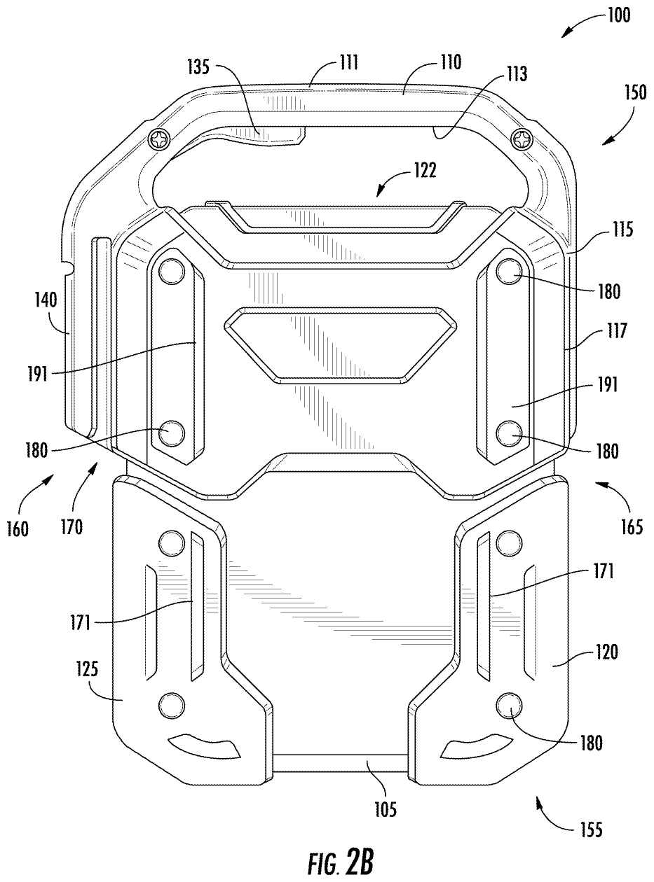

Referring to FIG. 1A, the upper modular portion 115 includes slots or channels 181 formed on the casing 117. The lower modular portions 120, 125 each include slots or channels 183 formed thereon. One of the slots 181 formed on the upper modular portion 115 aligns with a slot 183 formed on the lower modular portion 120 and a second of the slots 181 formed on the upper modular portion 115 aligns with a second slot 183 formed on the lower modular portion 125. As shown in FIGS. 1A and 2A, the aligned slots 181, 183 form two aligned slots 185 when the upper modular portion 115 and the lower modular portions 120, 125 are coupled to the battery pack 105. The aligned slots 185 serve to guide the battery assembly 100 onto a charging station or a piece of equipment, as described further herein. Alternatively, as shown in FIGS. 1B and 2B, the upper modular portion 115 additionally includes upper modular portion protrusions or bumpers 191 and the lower modular portions 120, 125 include lower modular portion protrusions or bumpers 171. The bumpers 171, 191 allow for cushioning if the battery assembly 100 falls on its side and double as an alignment feature when the battery assembly 100 is inserted into or coupled with a piece of equipment. The bumpers 171, 191 guide the battery assembly 100 onto the equipment such that an operator can easily align the battery assembly 100 with a receiver interface on a tool.

The handle 110 includes an outer surface 111 and an inner surface 113 positioned nearer the battery pack 105 than the outer surface 111. As shown in FIGS. 1-3, the inner surface 113 includes a release mechanism or movable member 135 configured to be operable by the operator to unlock and decouple the battery assembly 100 from a charging station and/or a piece of equipment. When depressed, the movable member 135 moves inward toward the inner surface 113 and unlocks the battery assembly 100 out of engagement with a respective feature on a charging station and/or piece of equipment. In this way, when an operator grasps the handle 110, the operator can, at the same time and with the same hand, easily depress the movable member 135 to disengage the battery assembly 100 from a piece of equipment or charging station.

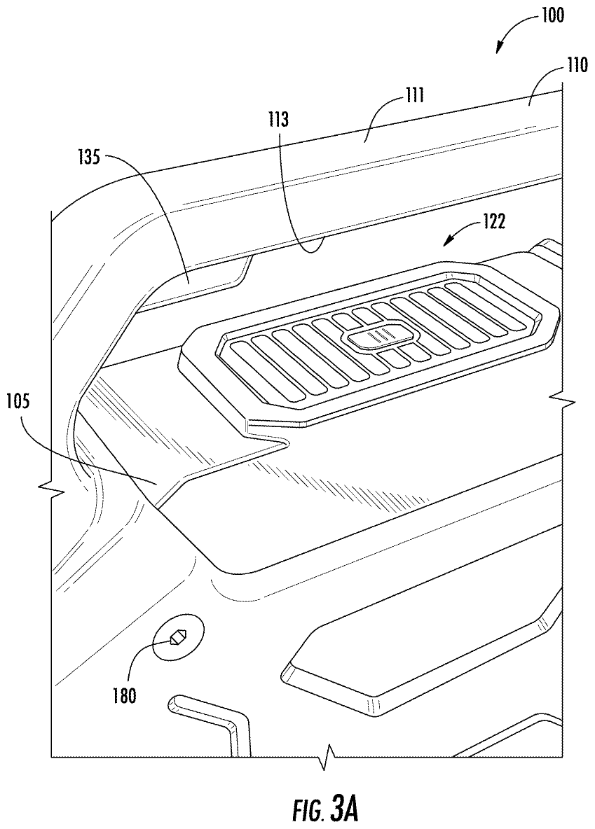

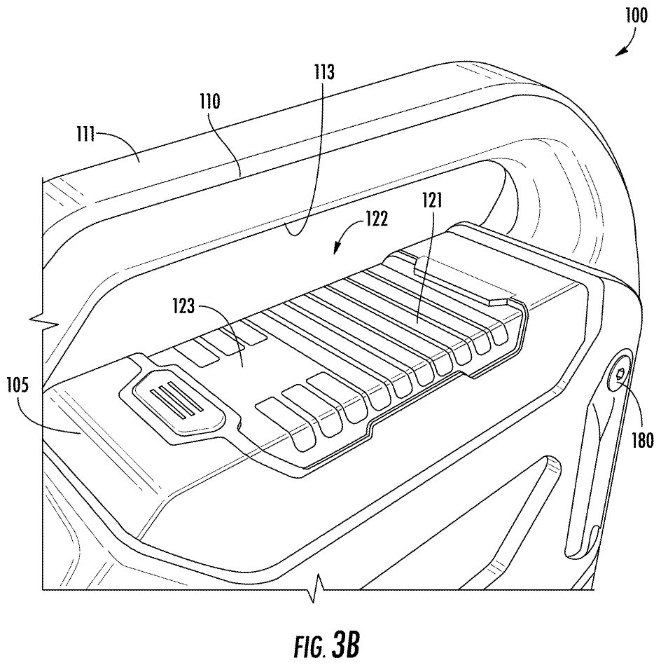

Referring to FIGS. 3A-3B, the battery pack 105 further includes a user interface 122 configured to display various status and fault indications of the battery assembly 100. The user interface 122 uses light-emitting diodes (LEDs) (on LED display 121), liquid crystal display (on LCD display 123), etc., to display various colors or other indications. The LED display 121 can provide battery charge status, and can blink or flash battery fault codes. The LCD display 123 can provide additional information about the battery assembly 100 including condition, tool specific data, usage data, faults, etc. For example, battery indications may include, but are not limited to, charge status, faults, battery health, battery life, battery mode, unique battery identifier, link systems, etc.

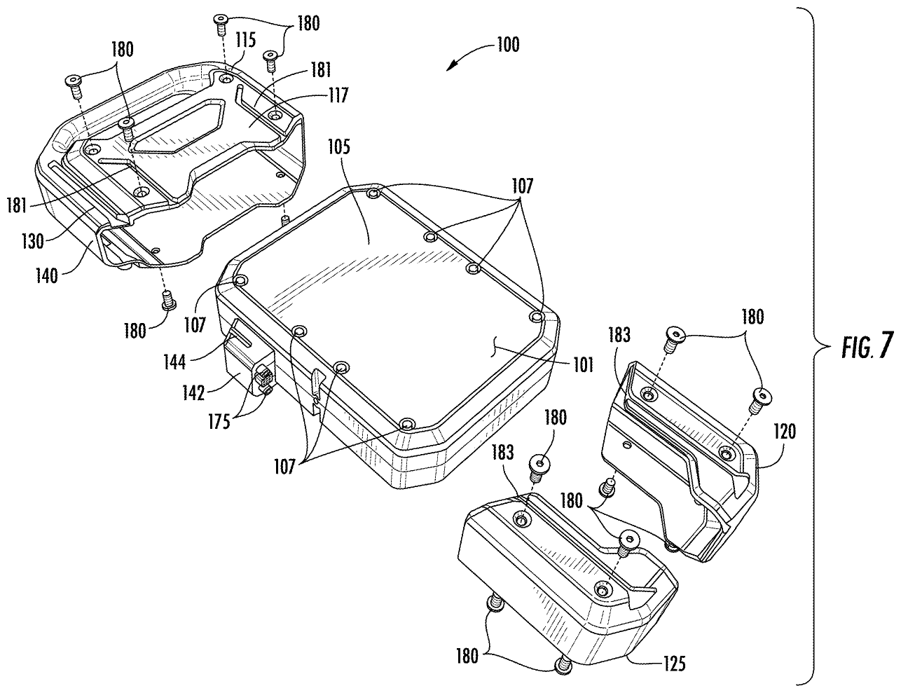

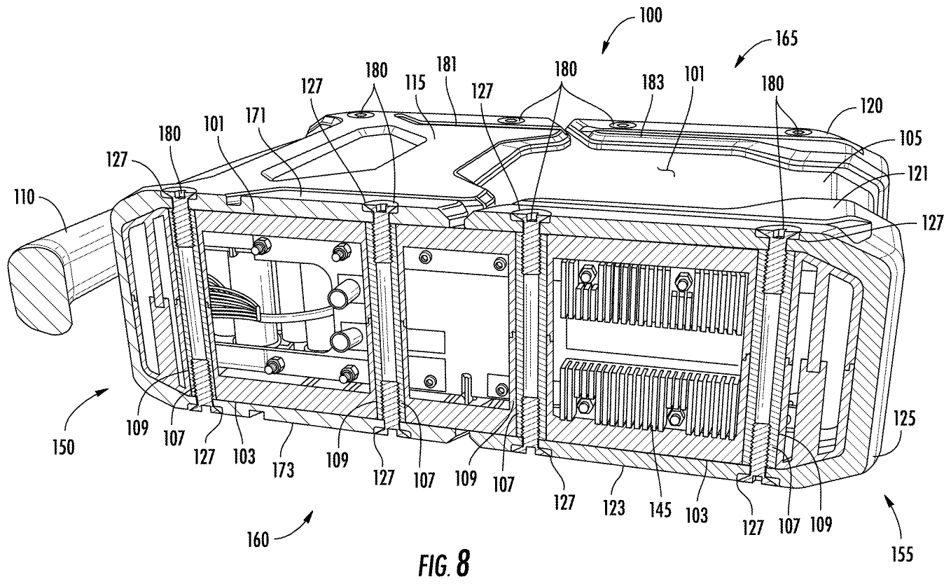

Referring to FIGS. 7-8, the battery assembly 100 is shown in an exploded view and a section view, according to an exemplary embodiment. Fasteners 180 are inserted through both the front face 101 and the rear face 103 of the battery pack 105 described further herein. The battery assembly 100 includes spacers 109 inserted through the battery pack 105 and extending from the front face 101 to the rear face 103 of the battery pack 105. In some embodiments, the spacers 109 are threaded on each end to receive the fasteners 180 at each face of the battery pack 105.

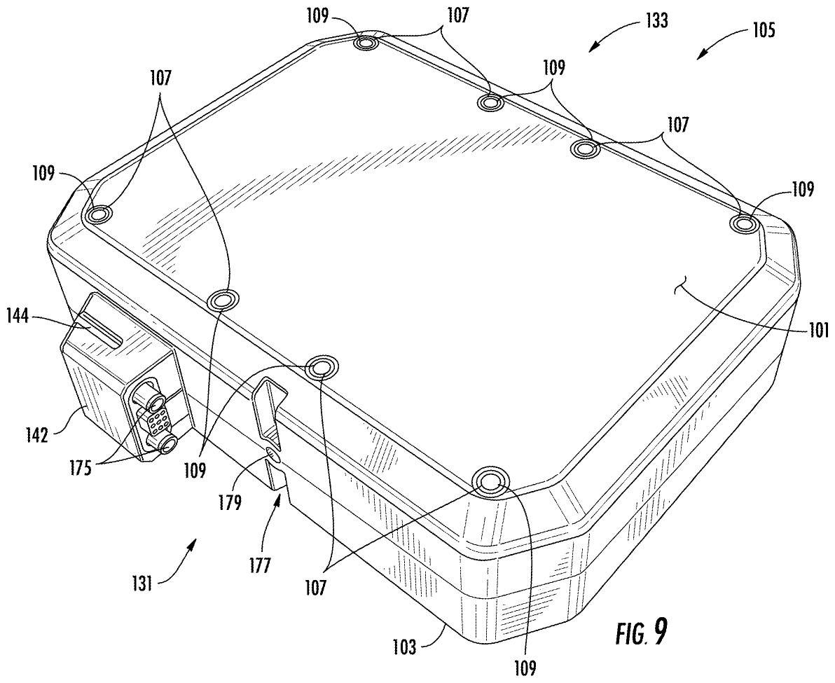

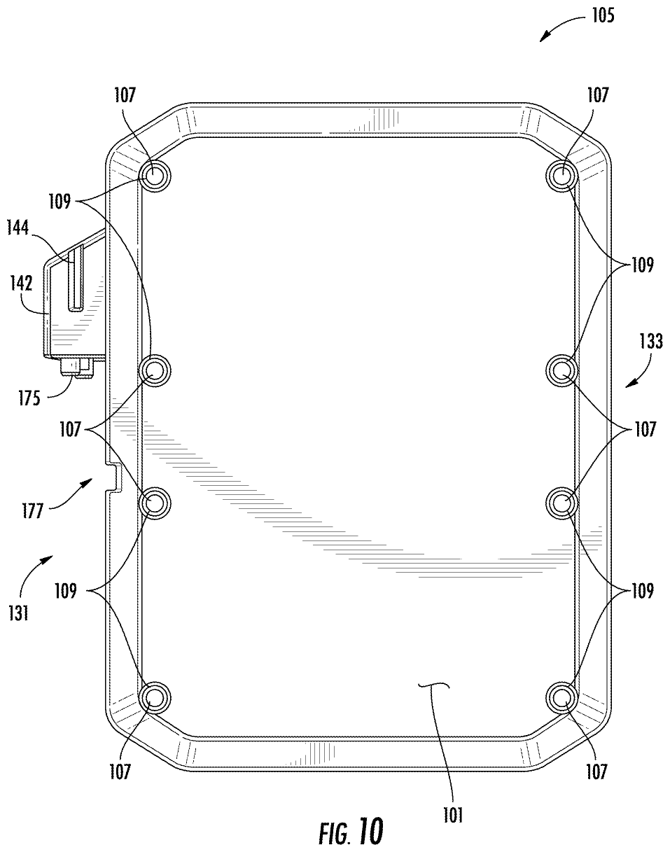

Referring to FIGS. 9-11, the battery pack 105 is shown, according to an exemplary embodiment. The battery pack 105 includes a front face 101, a rear face 103, a left side 131, and a right side 133. The battery pack 105 includes apertures 107 (e.g., through holes) extending from the front face 101 to the rear face 103. As described above, spacers 109 are inserted through the apertures 107 and extend through the battery pack 105 from the front face 101 to the rear face 103.

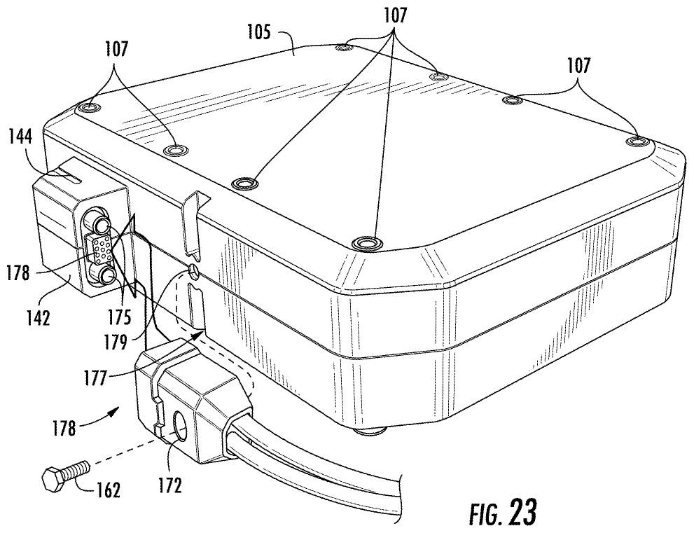

The battery pack 105 includes a connector portion 142 includes one or more ports 175 configured to mate with charging connectors on a charger or charging station. The connector portion 142 is housed within the mating portion 140 of the upper modular portion 115 when the upper modular portion 115 is coupled to the battery pack 105. Accordingly, the ports 175 are accessible through the mating portion 140 of the battery assembly 100 as described above. In this way, the upper modular portion 115 may serve to protect the ports 175 from damage due to being knocked during installation on a charging station and/or onto power equipment or serve to limit the amount of debris and/or liquid reaching or contacting the ports 175. The connector portion 142 includes a connector portion slot 144 configured to aid in guiding and/or positioning the connector portion 142 into the mating portion 140 of the upper modular portion 115. The battery pack 105 also includes an inset portion 177 positioned on the left side 131 including an aperture 179 (e.g., threaded hole) configured to receive a fastener 162 (e.g., threaded fastener, bolt) to couple to a power connector 178 (shown in FIG. 23), as described further herein.

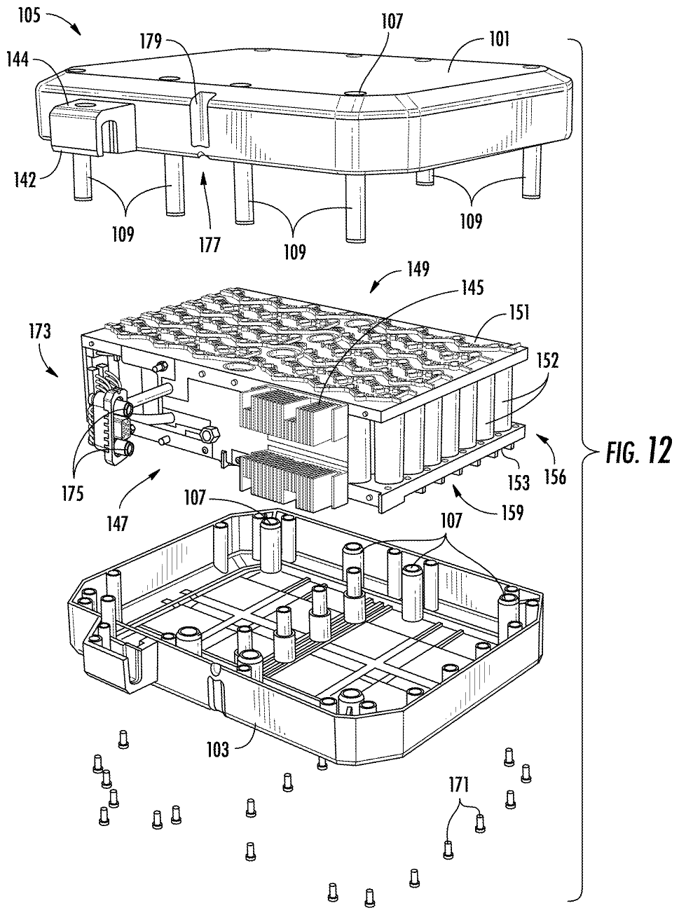

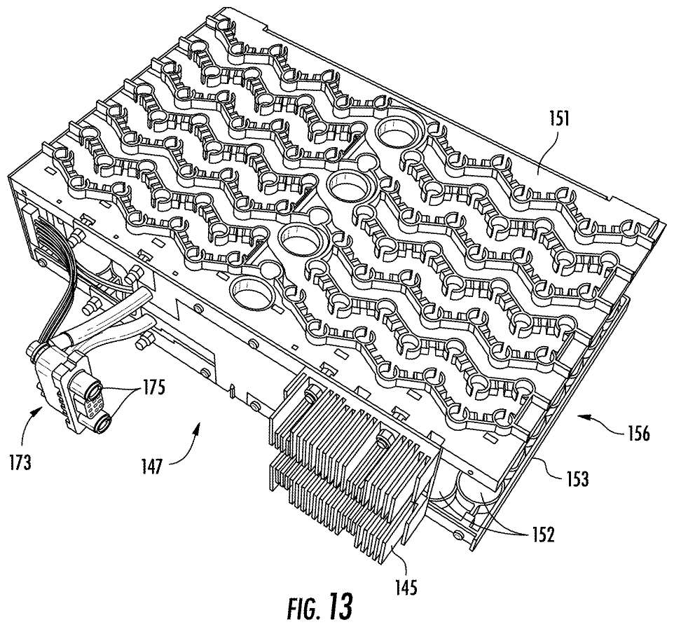

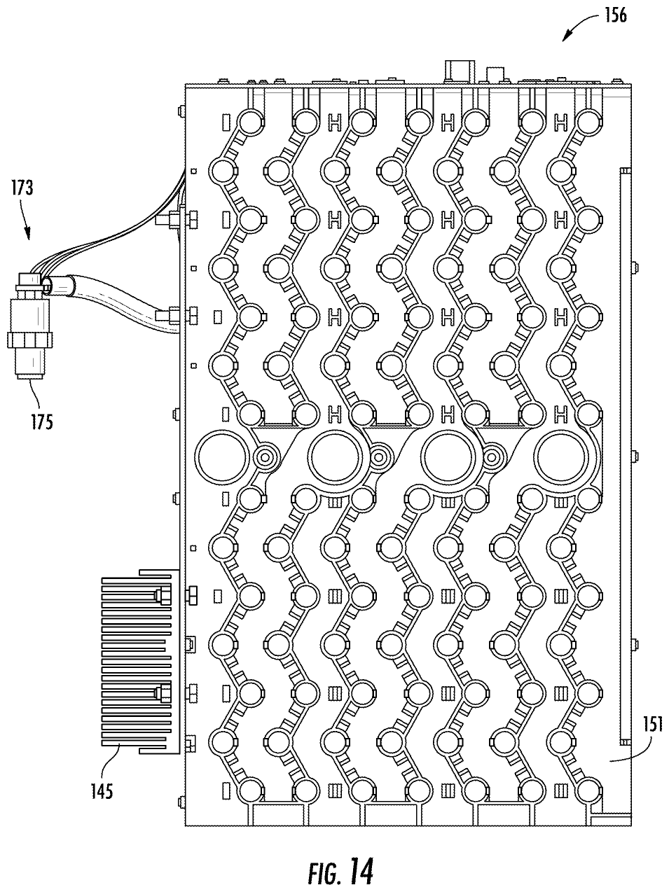

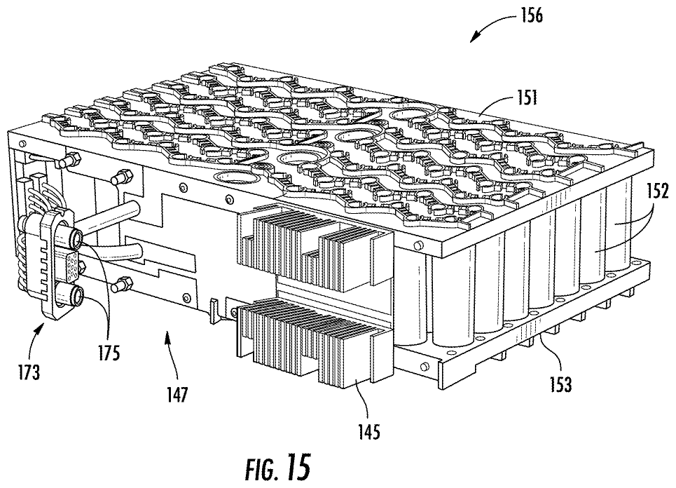

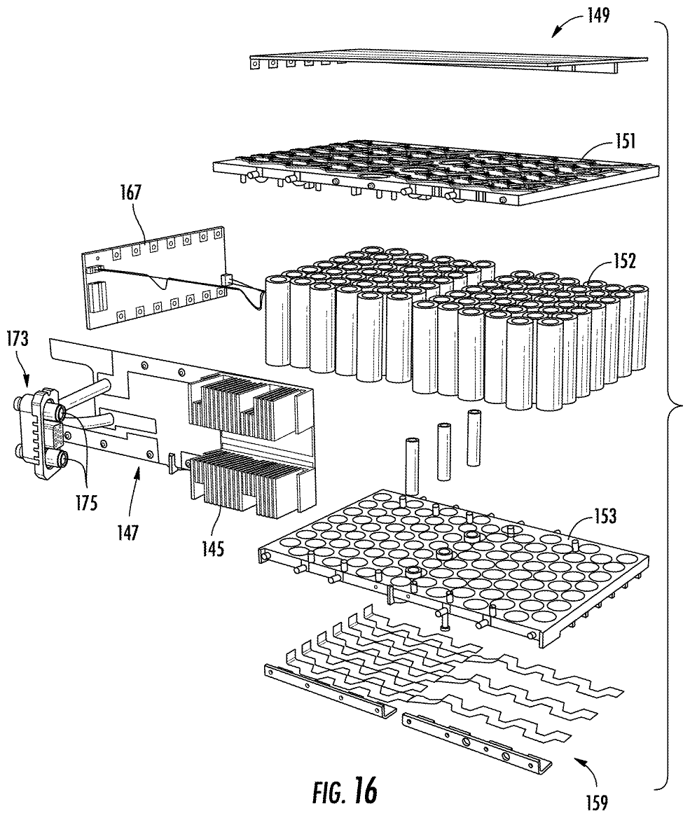

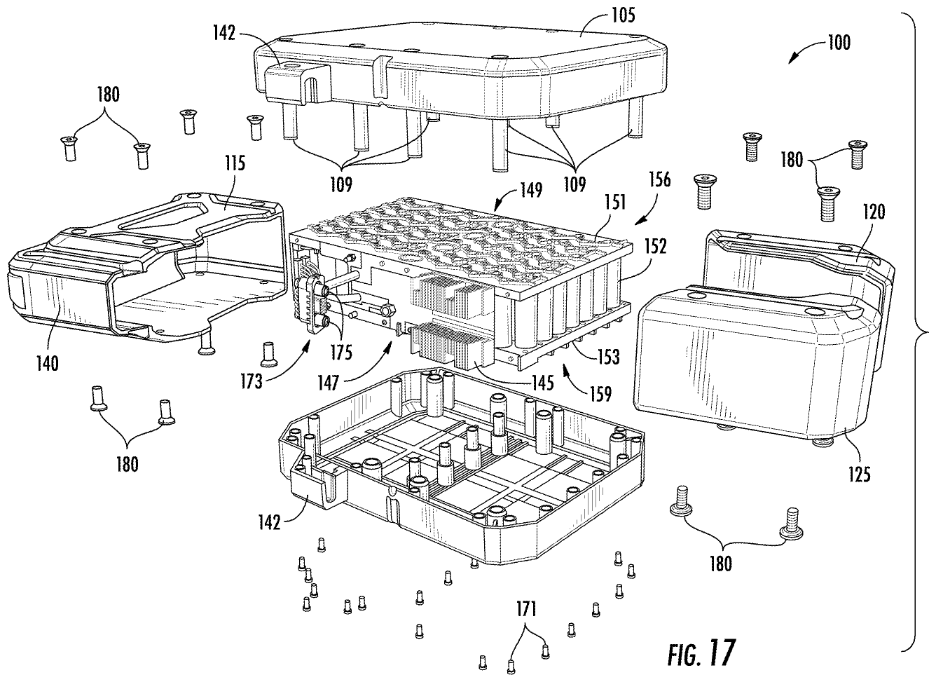

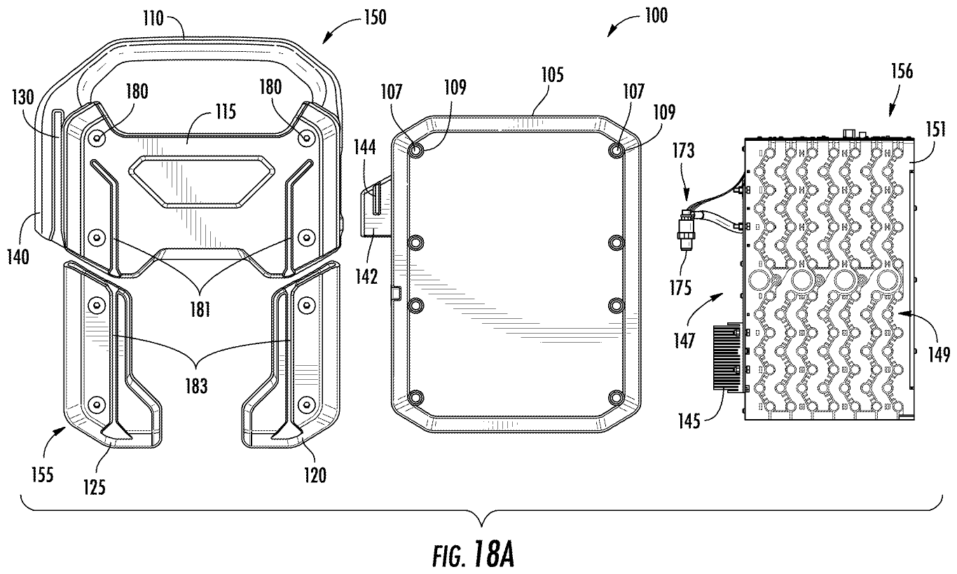

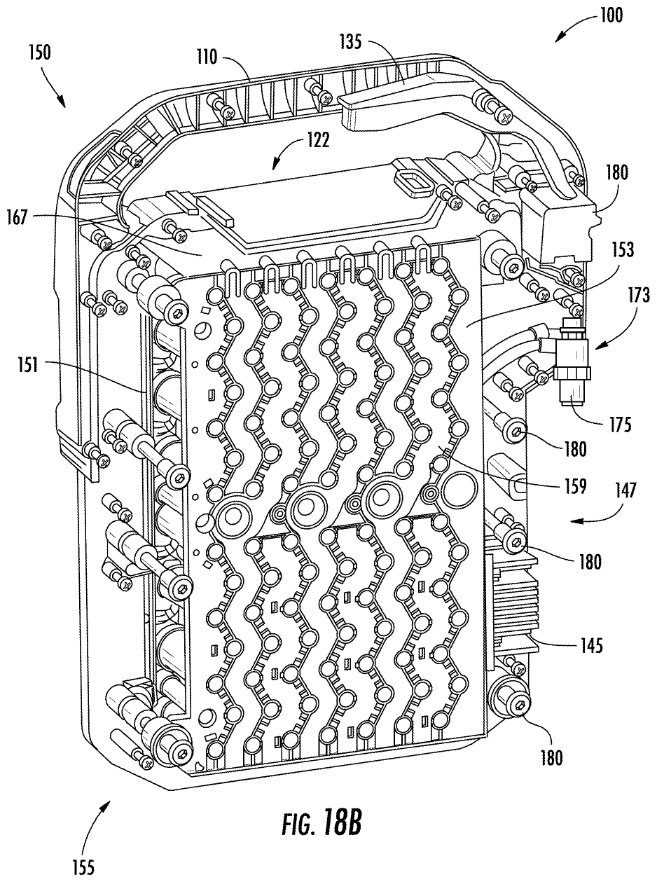

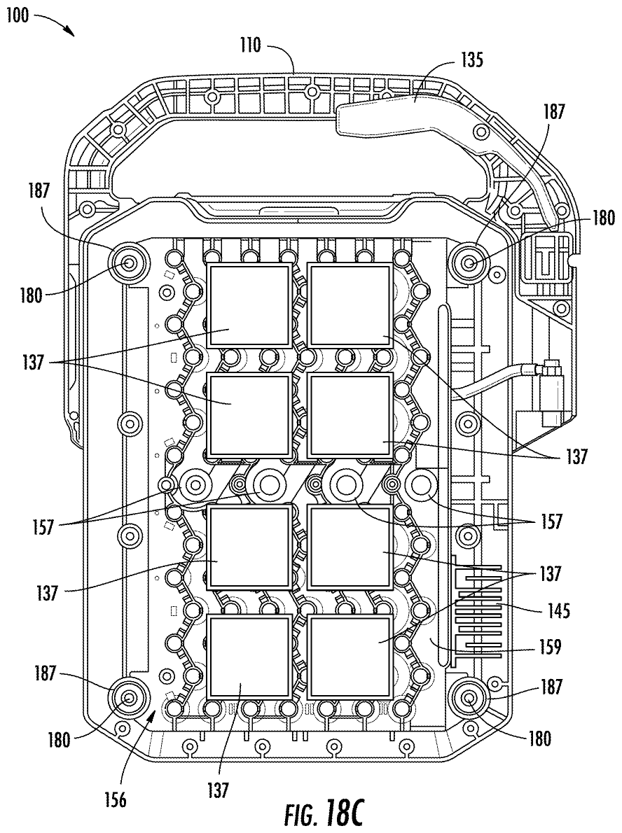

Referring to FIGS. 12-18C, the battery pack 105 includes a cell assembly 156 having a top cell holder 151, a bottom cell holder 153, and one or more battery cells 152 positioned therebetween. The battery pack 105 includes top collector plates 149 positioned on or proximate the top cell holder 151 and bottom collector plates 159 positioned on or proximate the bottom cell holder 153. The collector plates 149, 159 electrically connect the battery cells 152 together. The collector plates 149, 159 create both parallel and series electrical connections and also electrically connect to the BMS 167, as described further herein. The battery cells 152 are shown oriented vertically (i.e., each battery cell 152 has an axis extending longitudinally through an entire length of each of the battery cells 152 normal to a cross-sectional area of each of the battery cells 152). The battery cells 152 can be stacked to increase or decrease an electrical capacity of the battery assembly 100. In some embodiments, the battery cells 152 are horizontally oriented. As shown in FIG. 12, when the battery pack 105 is assembled, the spacers 109 are positioned on the outside of the cell assembly 156 and extend between the front face 101 and the rear face 103 of the battery pack 105. The configuration of the spacers 109 relative to the cell assembly 156 allows for separation of the cell assembly 156 from the housing of the battery assembly 100. In addition, the cell assembly 156 is isolated from the battery pack housing by multiple bushings and foam pads. As shown in FIG. 18C, one or more corner bushings 187 are positioned surrounding each corner spacer 109. One or more center bushings 157 are positioned proximate the center of the battery pack 105. One or more foam pads are positioned between the top cell holder 151 (e.g., top collector plates 149) and the battery pack housing and one or more foam pads are positioned between the bottom cell holder 153 (e.g., bottom collector plates 159) and the battery pack housing. In this way, the cell assembly 156 is protected during use of the battery pack 105 (e.g., installation, transport, potential drops, storing in truck bed or trailer, knocks, etc.) such that an impact or vibration if dropped or while on a piece of equipment limits or eliminates the harm done to the battery pack 105. In addition, the inside surfaces of the battery pack 105 may be packed with additional foam material to protect the cell assembly 156 and other internal components of the battery assembly 100.

A battery management system (BMS) 167 is positioned within the battery pack 105 and is electrically coupled to the cell assembly 156. When the battery assembly 100 is assembled, the BMS 167 is positioned near the upper portion 150 (shown in FIGS. 1A-1B) of the battery assembly 100 (e.g., underneath user interface 122). Referring to FIG. 18B, the BMS 167 is coupled to the cell assembly 156 and is electrically connected to the top collector plates 149 and the bottom collector plates 159. The electrically connection between the BMS 167 and the top collector plates 149 and the bottom collector plates 159 allows for a voltage reading across all of the parallel strings. Typically, this type of connection is made by running electrical wires across the entirety of the battery pack 105. By using the collector plates 149, 159, the electrical wires that are typically used to make this type of connection are eliminated, thereby reducing the use of wires within the pack 105. The BMS 167 is configured to manage the power output of the battery cells 152. The BMS 167 may be configured to allow the battery cells 152 to provide full power output to ports 175 to supply power to power equipment with which battery assembly 100 is connected. In some embodiments, the BMS 167 may allow battery cells 152 to be charged when battery assembly 100 is connected to charging stations. The BMS 167 may also be configured to shut off power output from battery cells 152 to ports 175, according to some embodiments. In some embodiments, the BMS 167 may also be configured to record and store data regarding usage, cycles, power level, rental duration, etc., of the battery assembly 100. The BMS 167 may also be configured to wirelessly connect to a remote database, a remote network, or a remote device, according to some embodiments. In some embodiments, BMS 167 may further be configured to control user interface 122. As noted above, the user interface 122 may display information to the operator, such as battery level, rental time remaining, error messages, etc.

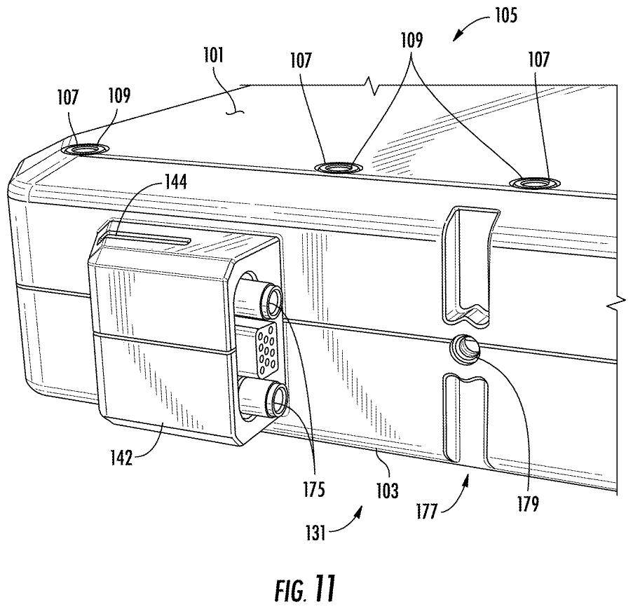

The battery assembly 100 includes an electrical connector 173 housed within the connector portion 142 of the battery pack 105. The electrical connector 173 includes the ports 175 and is electrically coupled to the cell assembly 156. The electrical connector 173 transfers power from the cell assembly 156 to the ports 175. The electrical connector 173 is positioned on the left side 131 of the battery pack 105, although it may be positioned otherwise (e.g., right side 133). The electrical connector 173 is also communicably and operatively coupled to a metal oxide-semiconductor field effect transistor (MOSFET) board 147. The battery pack 105 further includes a heat sink 145 positioned therein proximate the left side 131 (FIG. 11) of the battery pack 105. The heat sink 145 acts to regulate the temperature of the battery pack 105 by transferring the heat generated from the battery pack 105 to a fluid medium (e.g., air) where the heat is then dissipated away from the battery pack 105.

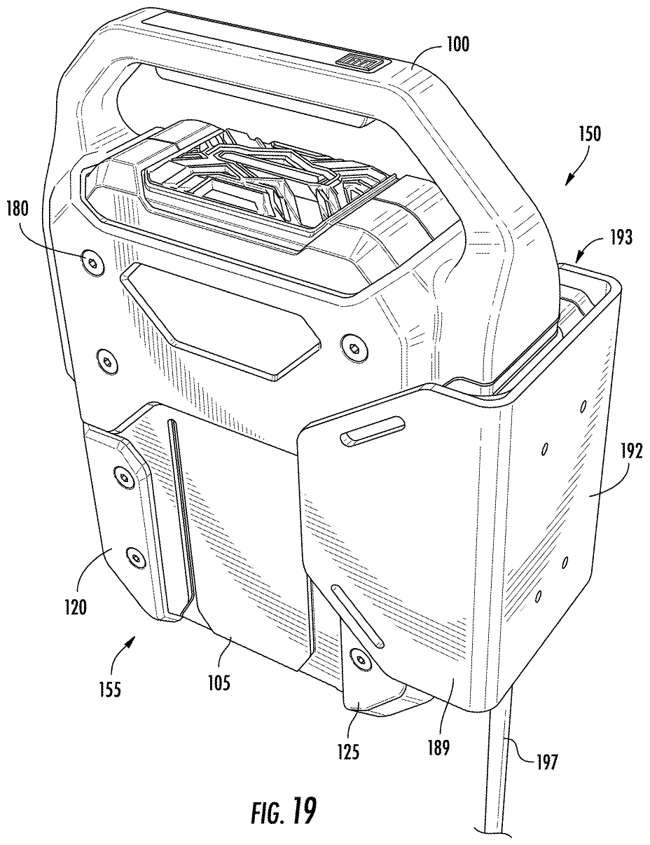

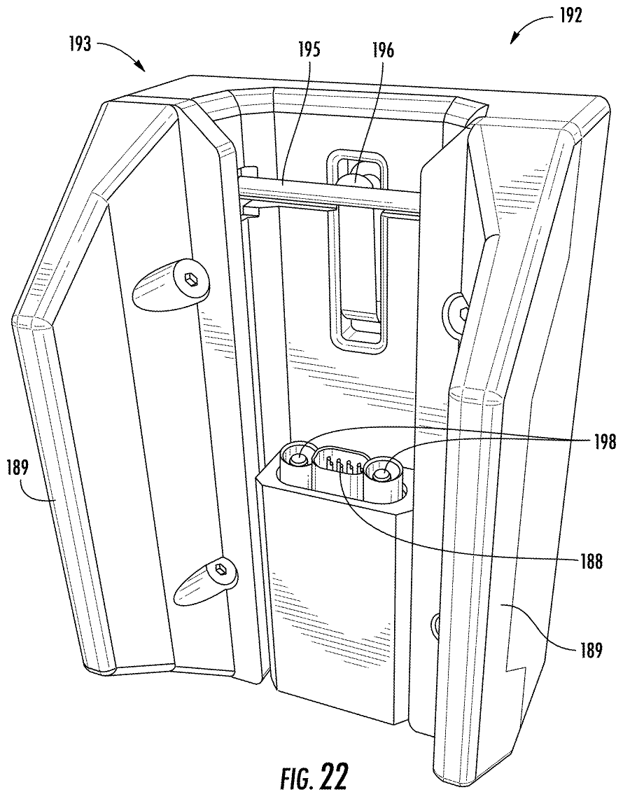

Referring to FIGS. 19-22, a portable charger 192 for use with the battery assembly 100 is shown, according to one embodiment. The portable charger 192 is plugged into the ports 175 and into a wall outlet (e.g., via cord 197) to provide charging to the battery assembly 100. The portable charger 192 includes two vertical walls 189 with a receptacle 193 between. The battery assembly 100 is configured to slide into the receptacle 193 and lock into place on the portable charger 192. As shown in FIGS. 20 and 22, the portable charger 192 includes two male connectors 198 configured to mate with the ports 175 on the battery assembly 100 in an installed position of the portable charger 192. The portable charger 192 also includes a horizontal member 195 and a movable member 196 that operate together to couple the portable charger 192 onto the mating portion 140 of the battery assembly 100. In some embodiments, using the portable charger 192, the battery assembly 100 will fully charge in approximately 4 hours.

Referring to FIG. 23, the battery pack 105 and a power connector 178 is shown, according to an exemplary embodiment. The power connector 178 slides onto the connector portion 142 of the battery pack 105 and couples with the ports 175. To couple the power connector 178 to the battery pack 105, a fastener 162 is inserted through an aperture 172 on the power connector 178 and fastens to an aperture 179 (e.g., threaded hole) on the battery pack 105. In this way, the lateral movement of the power connector 178 is limited, reducing the stress put on the ports 175.

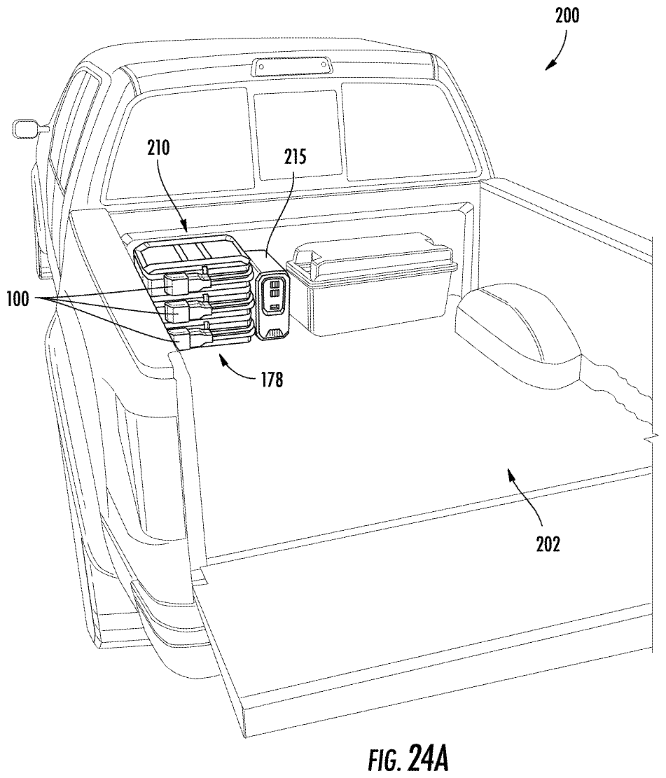

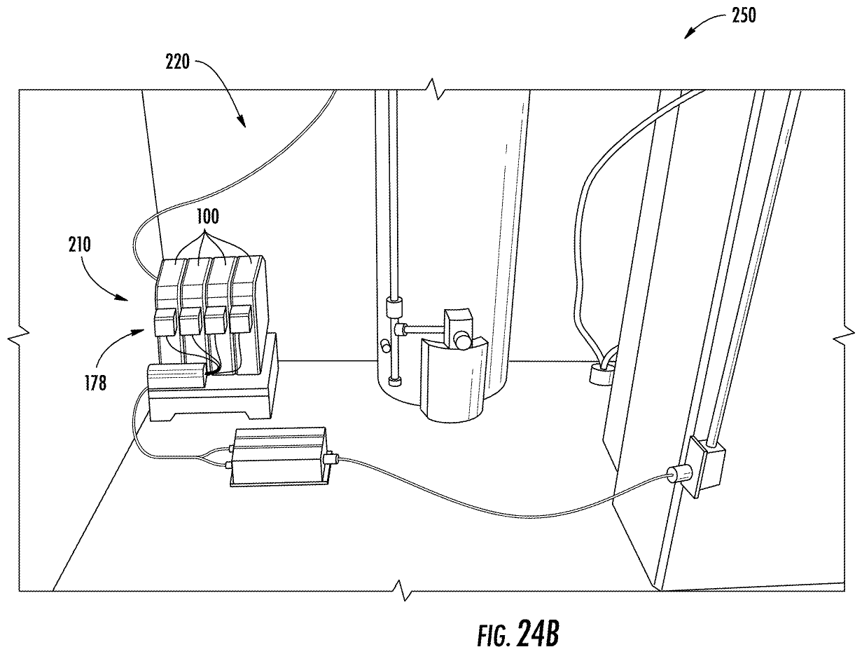

Referring to FIGS. 24A-24B, the battery assembly 100 is shown in environments 200 and 250 in use a multiple battery system 210 having multiple battery assemblies 100. Each battery assembly 100 is coupled to a power bank 215 through a power connector 178. The multiple battery system 210 can be transported easily, for example, in the bed 202 of a truck, as shown in FIG. 24A and as backup power 220 in a home or business. The multiple battery system 210 is relatively compact in size.

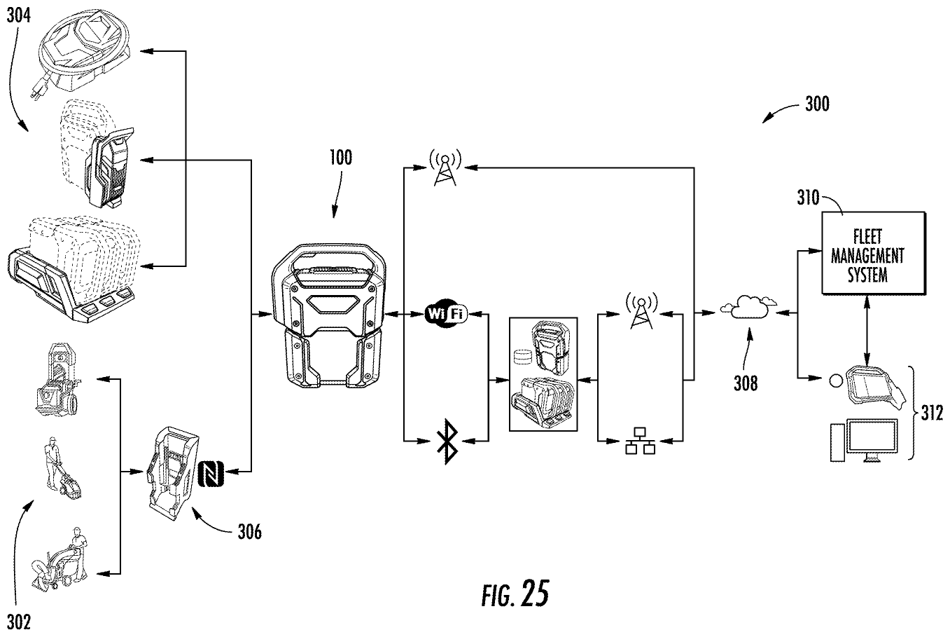

Referring to FIG. 25, in some embodiments, the battery assembly 100 is shown in a connection environment 300, according to an exemplary embodiment. The battery assembly 100 is capable of coupling to and communicating with various types of charging systems or stations 304, as described further herein. The battery assembly 100 is also configured to couple (e.g., via Near Field Communication through device 306) to various types of power equipment 302. The battery assembly 100 is connected to a network 308. The network 308 allows for connectivity and communication between the battery assembly 100 and various other devices. In some embodiments, the battery assembly 100 is connected to other battery assemblies 100, charging stations, or other devices, via Wi-Fi, Bluetooth, or other data communication systems. In some embodiments, operators and/or employees communicate over the network 308 to the battery assembly 100 via personal or mobile devices 312, such as smartphones, laptop computers, desktop computers, tablet computers, and the like. Accordingly, one or more mobile devices 312 are also connected to the network 308. In some embodiments, a fleet management system 310 is communicably and operatively coupled to the battery assembly 100 via the network 308.

In some embodiments, the battery assembly 100 includes a network interface. In some arrangements, the network interface includes the hardware and logic necessary to communicate over multiple channels of data communication. For example, the network interface may include a Wi-Fi interface, a cellular modem, a Bluetooth transceiver, a Bluetooth beacon, an RFID transceiver, an NFC transceiver, or a combination thereof. The network interface facilitates data communication to and from the battery assembly 100 (and therefore the equipment 302 on which the battery assembly 100 is used). The battery assembly 100 can communicate wirelessly with multiple other devices, including another battery assembly 100, in a mesh network. In this way, the battery assembly 100 can communicate status and usage information as well as configuration data.

Data communication between the battery assembly 100 and the mobile device 312 in various combinations may be facilitated by the network 308. In some arrangements, the network 308 includes cellular transceivers. In another arrangement, the network 308 includes the Internet. In yet another arrangement, the network 308 includes a local area network or a wide area network. The network 308 may be facilitated by short and/or long range communication technologies including Bluetooth transceivers, Bluetooth beacons, RFID transceivers, NFC transceivers, Wi-Fi transceivers, cellular transceivers, wired network connections, etc. As such, in one embodiment, the communication between the mobile device 312 and the battery assembly 100 can be facilitated by and connected to a cloud-based system via RFID and Wi-Fi connections on the battery assembly 100. In another embodiment, the communication can be facilitated by and connected to a cloud-based system via Wi-Fi only. In another embodiment, the communication can be facilitated by and connected to a cloud-based system via cellular transceivers. In yet another embodiment, the communication can be facilitated by and connected to a cloud-based system via Bluetooth and cellular transceivers. In all such embodiments, the cloud-based system can be made accessible to a third party, such as a consumer and/or rental company. To communicate via a cloud-based system, a gateway is included. The gateway can be a dedicated device, a charger, or another battery assembly 100.

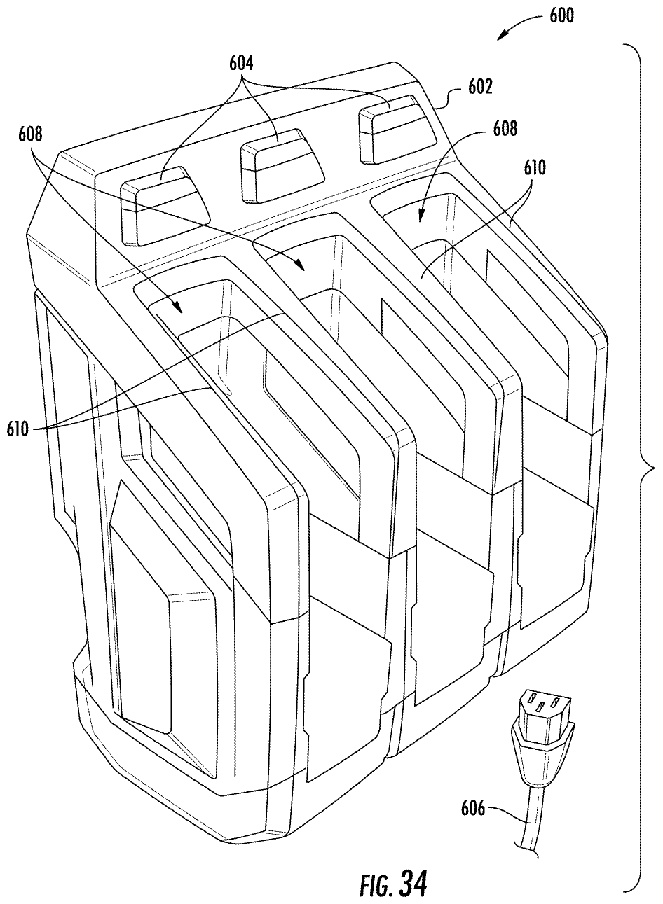

The battery assembly 100 (e.g., battery management system 167, other circuitry) includes a communications interface, according to some embodiments. In some embodiments, the communications interface may be an interface to communicable connect the battery assembly 100 to an external device. For example, the communications interface may allow the battery assembly 100 to serially communicate with the external device via SPI (serial peripheral interface), I2C (inter-integrated circuit), USB (universal serial bus), etc., or any other serial communications protocol. In some embodiments, the external device which battery assembly 100 communicates with is a charging station (e.g., bay charger system 600 as shown in FIG. 34). The battery assembly 100 may communicate with the charging station information regarding a status of battery assembly 100 (e.g., currently charging, fully charged, ready to use, reserved, etc.), according to some embodiments.

The battery assembly 100 may include one or more circuits configured to monitor the state of the battery assembly 100 or other aspects of the equipment with which the battery assembly 100 is used. A circuit may be further configured to monitor the state of the battery to predict the number of starts capable with the battery. For example, a circuit may monitor the state of charge of the battery, the average amount of power expended to start and run the equipment, and/or other characteristics of the equipment (e.g., run state, RPMs, etc.). The average amount of power expended to start the equipment and/or characteristics of the equipment may be communicated to the circuit through one or more of the terminals coupling the battery assembly 100 to the receiver. The number of starts capable with the battery assembly 100 may then be shown on a display integrated into the battery (e.g., user interface 122 shown in FIGS. 3A-3B) or a display provided elsewhere, such as on a control panel of a piece of power equipment. The number of starts capable with the battery assembly 100 may also be communicated to the mobile device 312 and displayed on a user interface of the mobile device 312. The number of starts capable with the battery assembly 100 may be calculated based on the characteristics of the equipment, for example, a battery having a specific charge may be able to perform more starts for one type of outdoor power equipment (e.g., a pressure washer) than for another type of outdoor power equipment (e.g., a lawn mower). The battery assembly 100 may also (e.g., through various circuits) determine the type of equipment on which the battery assembly 100 is being used. In this way, the battery assembly 100 can determine tailored inputs and outputs based on the type of equipment. In some embodiments, the battery assembly 100 can identify a tool wirelessly through an NFC tag installed on the tool interface. Accordingly, the battery assembly 100 can include an NFC reader. Once the battery assembly 100 is inserted into the tool interface, the battery assembly 100 reads the information from the NFC tag and is able to associate the battery assembly 100 usage data with that specific tool or piece of equipment. The battery assembly 100 can also reconfigure data pins specifically to the tool. The NFC tag could also be used to identify what slot the battery assembly 100 is plugged into if a tool has multiple battery slots.

A circuit may be further configured to monitor other characteristics of the equipment by communicating with sensors and monitoring devices (e.g., fluid level sensors, temperature sensors, pressure sensors, chronometers, etc.). The circuit may output data related to the information received from the sensors and monitoring devices to a display, such as the user interface 122 (FIGS. 3A-3B) integrated into the battery assembly 100 or a display shown on a user interface of a mobile device 312. The display may therefore communicate to the operator of the equipment various operational data related to the equipment and the battery assembly 100. For example, the circuit may output to the display information such as operational time, battery charge, or battery temperature. Additionally, the circuit may monitor the temperature of the battery assembly 100 via an input from a temperature sensor. Temperature monitoring can be used to alert the operator (e.g., via the user interface 122, user interface of the mobile device 312) if the battery temperature is too low for normal use of the battery. Using the battery assembly 100 to power these circuits allows information to be provided to the operator (e.g., battery temperature, battery charge level) prior to the equipment being started so that any issues can be addressed before attempting to start the equipment.

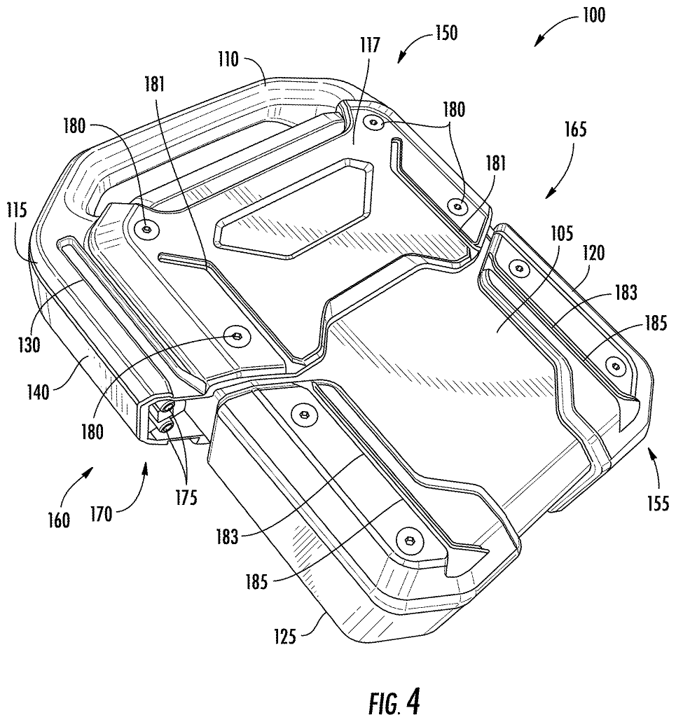

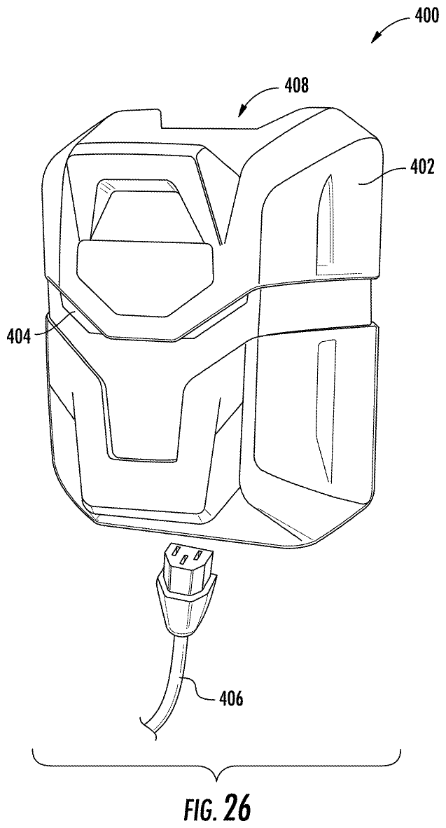

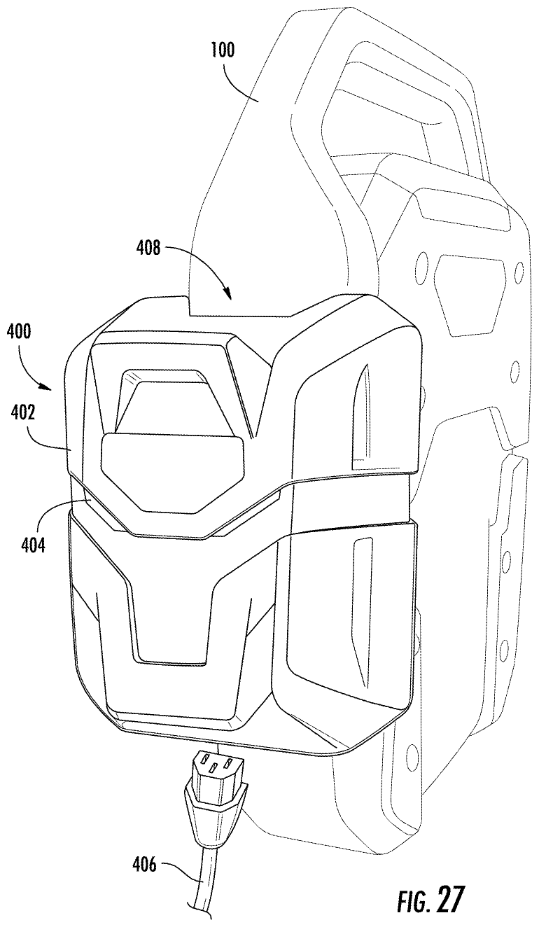

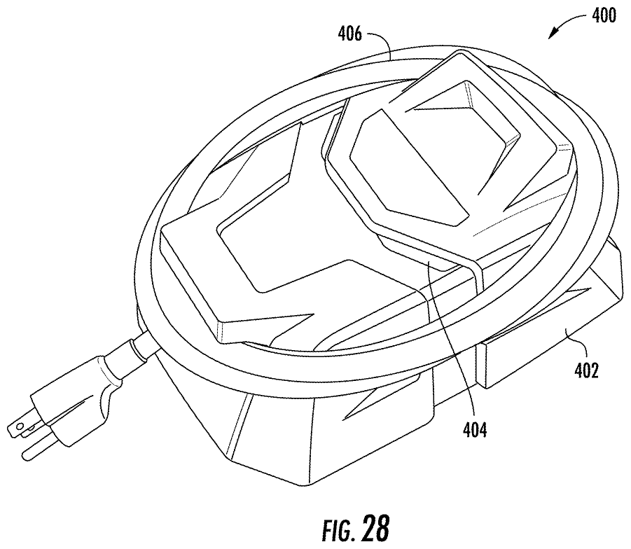

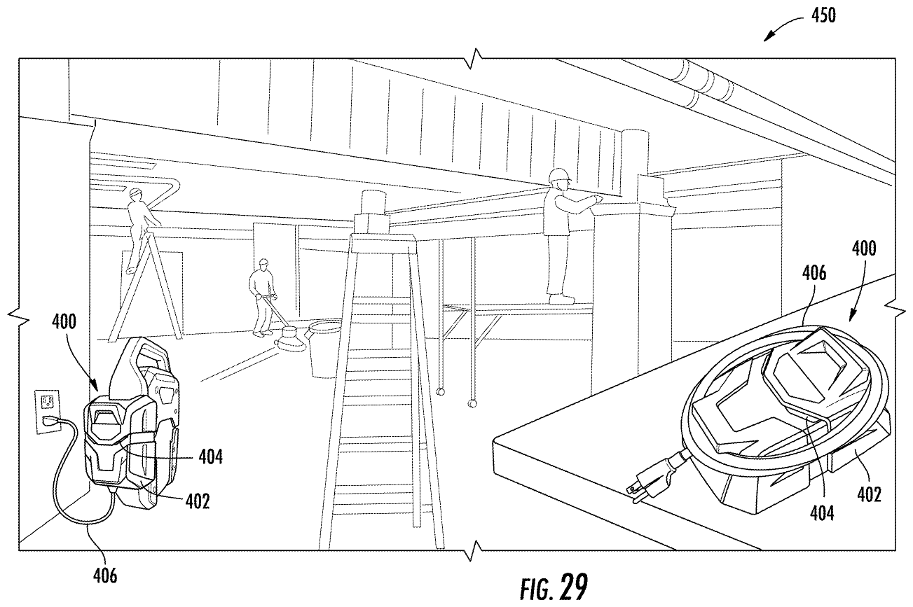

Referring to FIGS. 26-29, a compact charger is shown, according to an exemplary embodiment. The compact charger 400 is configured to couple to the battery assembly 100 and charge the battery assembly 100. In some embodiments, the compact charger 400 is a 400 Watt (W) charger. The compact charger 400 may charge the battery assembly 100 in approximately 3-4 hours. The compact charger 400 includes a charger body 402 and a receptacle 408. The compact charger 400 is configured to slide or otherwise couple to the battery assembly 100 (e.g., at mating portion 140) and electrically connect to the ports 175 (FIG. 4). A cord 406 couples to the compact charger 400 at one end and at a wall outlet at another end. The cord 406 supplies electricity to the compact charger 400, which then supplies power to the battery assembly 100. In some embodiments, the compact charger 400 stores electricity to provide to the battery assembly 100 without having to be plugged into the cord 406 or wall outlet. In some embodiments, the compact charger 400 includes an indicator light 404 which may provide a status indication to an operator. For example, when the indicator light 404 is on, the operator is provided an indication that the compact charger 400 is charging the battery assembly 100. As another example, when the indicator light 404 is a certain color, such as green, the compact charger 400 has charge and when the indicator light 404 is another color, such as red, the compact charger 400 is depleted. Referring to FIG. 28, the cord 406 may be wrapped around the charger 400 in a stored position.

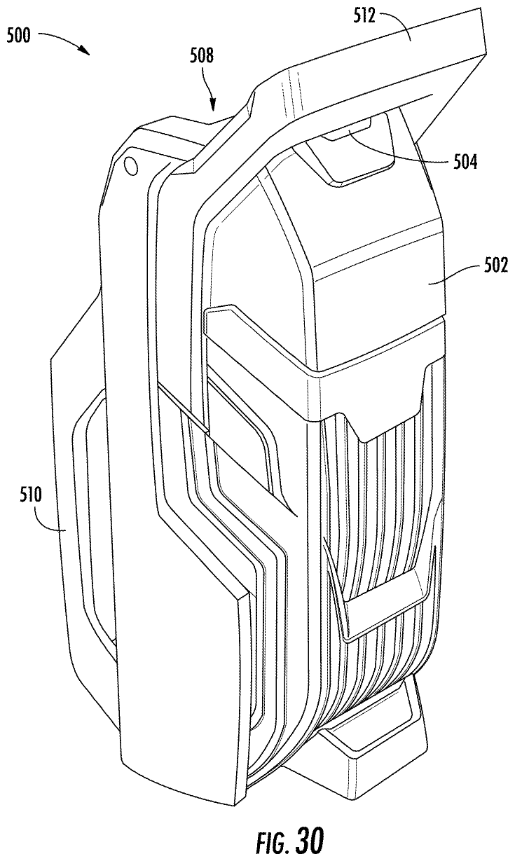

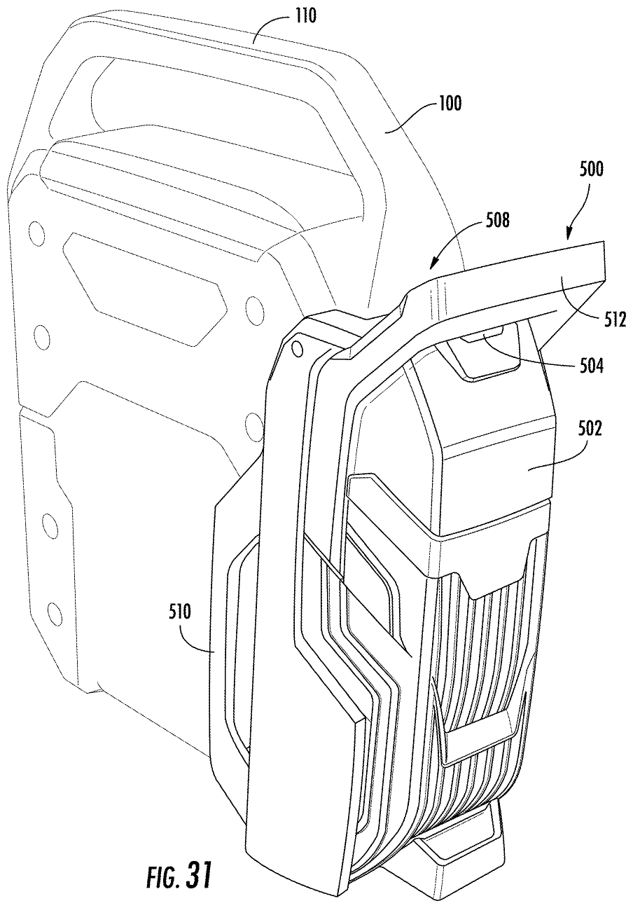

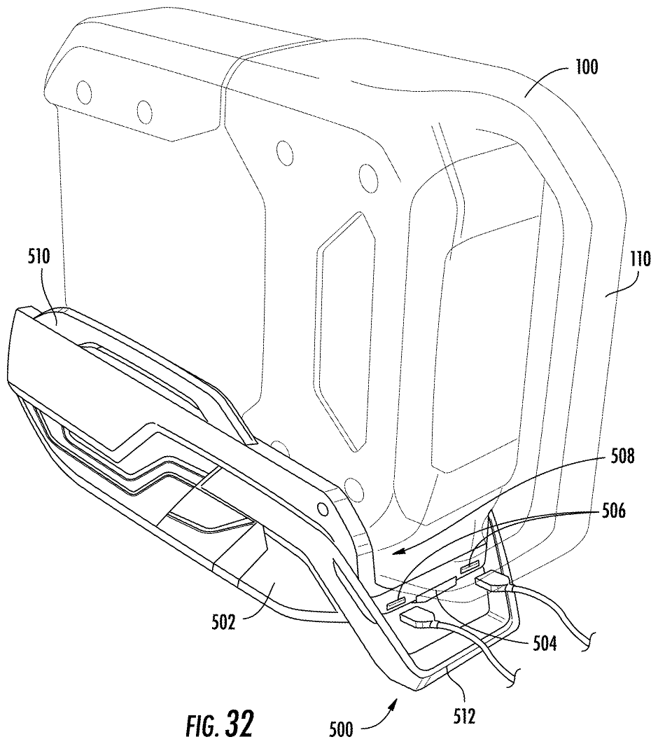

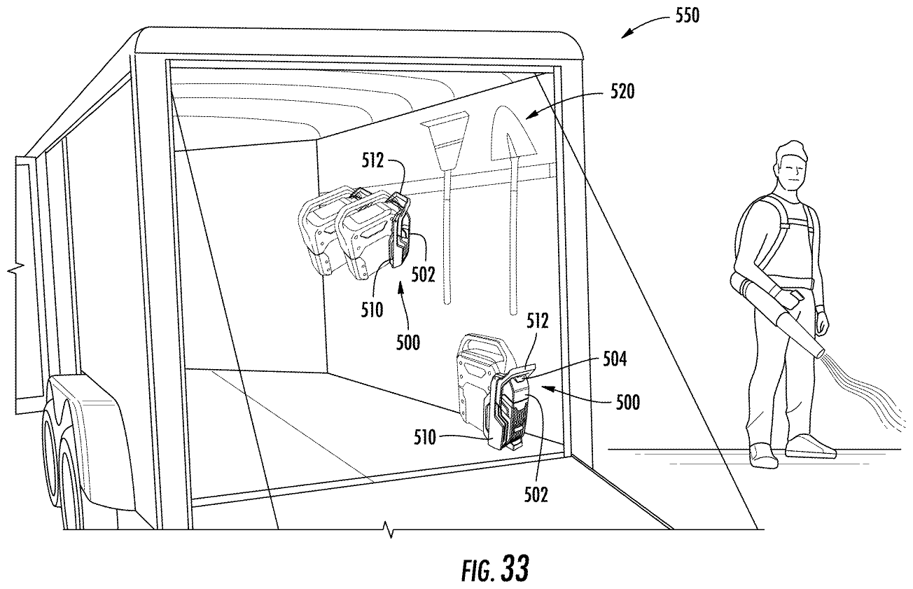

Referring to FIGS. 30-33, a fast charger is shown, according to an exemplary embodiment. The fast charger 500 is configured to couple to the battery assembly 100 and charge the battery assembly 100. In some embodiments, the fast charger 500 is a 1000 W charger. The fast charger 500 may charge the battery assembly 100 in approximately 1.5 hours. The fast charger 500 includes a charger body 502 and a receptacle 508. The fast charger 500 is configured to slide or otherwise couple to the battery assembly 100 (e.g., at mating portion 140) and electrically connect to the ports 175 (FIG. 4). Cords can be inserted into charging ports 506 (e.g., USB ports) to charge the fast charger 500. The fast charger 500 is configured to be used without connections to a wall outlet. An operator can select whether to use rapid charging mode (e.g., by pressing a rapid charge mode selection) or a lower rate charging mode and a lower rate charging mode may be a default mode. As shown in FIGS. 31-32, the fast charger 500 may be coupled to the battery assembly 100 and positioned in either a vertical position or horizontal position. The fast charger 500 also includes a handle 512 and two wall portions 510. In an installed position, the two wall portions 510 are on either side of the battery assembly 100. The handle 512 can be grasped by an operator to maneuver the charger 500 (e.g., couple and decouple the charger 500 from the battery assembly 100). In some embodiments, the fast charger 500 includes an indicator light 504 which may provide a status indication to an operator. Referring to FIG. 33, the fast charger 500 is shown used in a use environment 550. For example, the fast charger 500 is shown in the inside of a vehicle 520, positioned on the floor of the vehicle 520 and hanging on an inside wall of the vehicle 520.

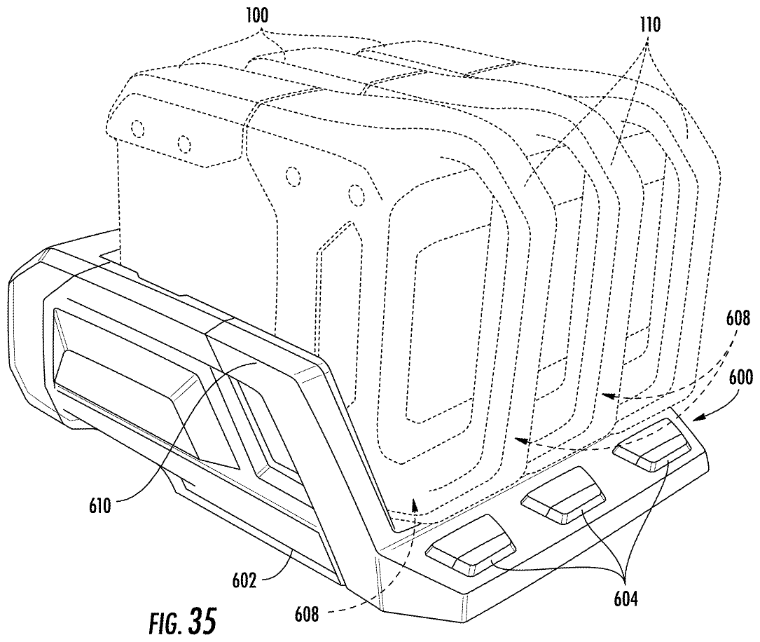

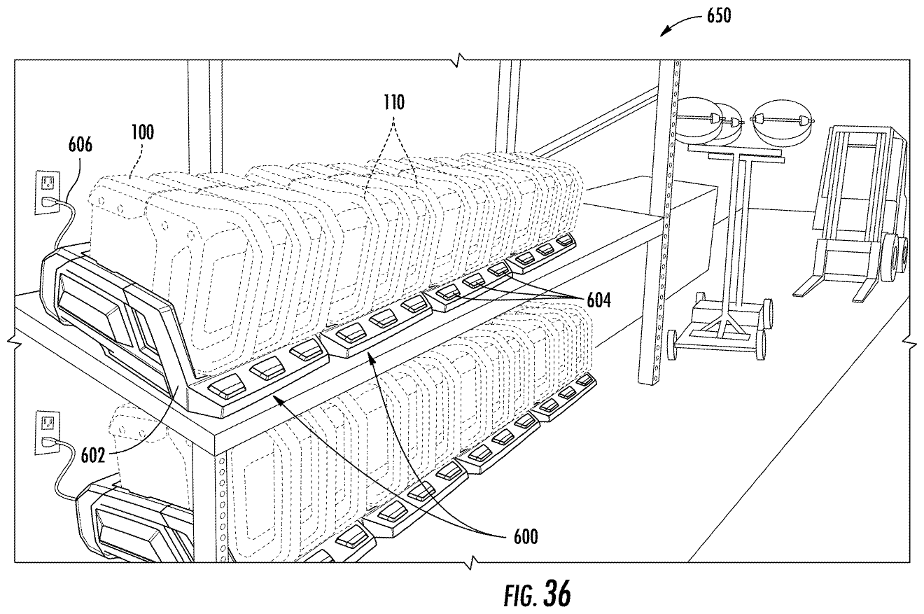

Referring to FIGS. 34-36, a bay charger 600 is shown, according to an exemplary embodiment. The bay charger 600 is configured to couple to multiple battery assemblies 100 and charge the multiple battery assemblies 100 simultaneously. In some embodiments, the bay charger is a 400 W bay charger, providing 400 W of power to each of the battery assemblies 100 coupled thereto. The bay charger 600 includes a charger body 602 and multiple receptacles 608 defined by multiple wall portions 610. Each of the receptacles 608 is configured to receive or otherwise couple to each battery assembly 100 and electrically connect to the ports 175 (FIG. 4) of the battery assembly 100. A cord 606 couples to the bay charger 600 at one end and a wall outlet at another end. In some embodiments, the bay charger 600 includes an indicator light 604 for each of the battery receptacles 608. The indicator lights 604 provide a status indication to an operator for the battery assembly 100 coupled to that receptacle 608. As shown in FIG. 36, multiple battery assemblies 100 are inserted into and coupled to the receptacles 608 and stored on a shelf in a storage or display environment 650. When an operator desires to remove one of the battery assemblies 100, the handle 110 of the battery assembly 100 is grasped, the movable member 135 is engaged (e.g., squeezed, pushed in), and the battery assembly 100 is removed by sliding the battery assembly 100 out of the receptacle 608. The bay charger 600 may include one or more controllers configured to ensure proper charging of all the battery assemblies 100.

In some embodiments, the bay charger 600 uses sequential charging while charging multiple battery assemblies 100. Sequential charging includes charging different battery assemblies 100 at different times so that not all battery assemblies 100 are charged at once potentially resulting in an overload on the utility service system. The sequential charging may determine which battery assemblies 100 need to be charged more than others by monitoring the charge levels of all connected battery assemblies 100 and supply charge to those assemblies 100 while switching off power supply to battery assemblies 100 that may already be fully charged. The sequential charging may also determine the order in which the battery assemblies 100 were inserted into the bay charger 600 and charge the battery assemblies according to that order.

In addition to the charging systems described above, the battery assembly 100 can also be charged while inserted on the equipment or tool on which the battery assembly 100 is used. An operator can leave the battery assembly 100 inserted and plug the equipment or tool into an outlet to charge the battery assembly 100. In this embodiment, the charging system is included with the tool or equipment such that no external charger is necessary.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

It should be understood that while the use of words such as desirable or suitable utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” or “at least one” are used there is no intention to limit the claim to only one item unless specifically stated to the contrary in the claim.

It should be noted that certain passages of this disclosure can reference terms such as “first” and “second” in connection with side and end, etc., for purposes of identifying or differentiating one from another or from others. These terms are not intended to merely relate entities (e.g., a first side and a second side) temporally or according to a sequence, although in some cases, these entities can include such a relationship. Nor do these terms limit the number of possible entities (e.g., sides or ends) that can operate within a system or environment.

The terms “coupled” and “connected” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicably coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

What is claimed is:

1. A power system for power equipment comprising:
a battery having a capacity of at least 300 Watt-hours and including a battery housing substantially enclosing the battery; and
a receiver comprising electrical terminals provided on the receiver, the electrical terminals selectively and electrically coupled to the battery;
wherein the receiver is configured to selectively couple with a portion of the battery housing and wherein the receiver is configured to be decoupled from the portion of the battery housing without the use of tools;
wherein the receiver further comprises a planar mounting surface including at least one aperture for receiving a threaded fastener; and
wherein the receiver is coupled to the power equipment via a threaded fastener.

2. The power system of claim 1, wherein the battery further comprises:
a battery pack having a battery pack housing;
a first modular housing portion coupled to the battery pack housing positioned at a first end of the battery pack housing;
a second modular housing portion coupled to the battery pack housing positioned at a second end of the battery pack housing;
a handle formed as part of the first modular housing portion; and
a plurality of battery cells disposed within the battery pack housing.

3. The power system of claim 2, where in the battery further comprises a first slot formed on the first modular housing portion and a second slot is formed on the second housing modular portion, the first slot and the second slot together forming an aligned slot configured to receive one of the plurality of protrusions of the receptacle.

4. The power system of claim 2, wherein the handle comprises a release mechanism configured to releasably couple the battery assembly to at least one of the piece of power equipment and the charging station when the release mechanism is in a released position.

5. The power system of claim 4, wherein the release mechanism is positioned on an inner surface of the handle and extends along at least a portion of the handle.

6. The power system of claim 2, wherein the battery comprises a heat sink positioned within the battery pack housing and configured to dissipate heat from the battery.

7. The power system of claim 2, wherein the battery further comprises a mating feature comprising a plurality of ports electrically connected to the plurality of battery cells and configured to supply power from the plurality of battery cells through the ports and configured to selectively connect the battery with a receptacle of at least one of a piece of power equipment and a charging station, wherein the mating feature is located on the first modular housing portion.

8. The power system of claim 7, wherein the mating feature comprises a slot configured to interface with a protrusion on the charging station to releasably couple the battery to the charging station.

9. The power system of claim 2, wherein the battery further comprises a battery management system positioned within the battery pack housing and configured to monitor a status of the battery and control an operation of the battery and further configured to wirelessly communicate information with at least one of a remote server and a personal computer, wherein the information communicated with at least one of the remote server and the personal computer is at least one of information regarding the status of the battery and a command.

10. A battery assembly comprising:
a housing comprising a first portion, a second portion, and a third portion connecting the first portion to the second portion, wherein the second portion is located opposite the first portion;
a handle located above the first portion;
a plurality of battery cells disposed within the housing;
a mating feature comprising a plurality of ports electrically connected to the plurality of battery cells and configured to supply power from the plurality of battery cells through the ports and configured to selectively connect the battery assembly with a receptacle of at least one of a power equipment and a charging station:
wherein the mating feature is located on the first portion of the housing.

11. The battery assembly of claim 10, further comprising a plurality of bumpers positioned on the first portion and the second portion, the plurality of bumpers configured to align the battery assembly into the receptacle of at least one of the power equipment and the charging station.

12. The battery assembly of claim 10, further comprising a user interface displaying battery status indications using light-emitting diodes (LEDs) and liquid crystal display (LCD), the user interface positioned on the third portion of the housing.

13. The battery assembly of claim 10, where in the battery further comprises a first slot formed on the first modular housing portion and a second slot is formed on the second housing modular portion, the first slot and the second slot together forming an aligned slot configured to receive one of the plurality of protrusions of the receptacle.

14. The battery assembly of claim 10, wherein the handle comprises a release mechanism configured to releasably couple the battery assembly to at least one of the piece of power equipment and the charging station when the release mechanism is in a released position.

15. The battery assembly of claim 14, wherein the release mechanism is positioned on an inner surface of the handle and extends along at least a portion of the handle.

16. A battery assembly comprising:
a housing comprising a handle;
a plurality of battery cells disposed within the housing; and
a mating feature comprising a plurality of ports electrically connected to the plurality of battery cells and configured to supply power from the plurality of battery cells through the ports and configured to selectively connect the battery assembly with a receptacle of at least one of a piece of power equipment and a charging station;
wherein the handle comprises a release mechanism configured to selectively disengage the battery assembly from at least one of the piece of power equipment and the charging station when the release mechanism is in a released position; and
wherein the housing comprises a plurality of channels configured to interface with a plurality of protrusions of the receptacle.

17. The battery assembly of claim 16, further comprising:
a lower housing modular portion; and
an upper housing modular portion;
wherein a first slot is formed on the lower housing modular portion and a second slot is formed on the upper housing modular portion, the first slot and the second slot together forming an aligned slot configured to receive one of the plurality of protrusions of the receptacle.

18. The battery assembly of claim 16, wherein the release mechanism is positioned on an inner surface of the handle and extends along at least a portion of the handle.

19. The battery assembly of claim 16, further comprising a controller configured to monitor a status of the battery assembly and control an operation of the battery assembly and further configured to wirelessly communicate information with at least one of a remote server and a personal computer, wherein the information communicated with at least one of the remote server and the personal computer is at least one of information regarding the status of the battery assembly and a command.

20. The battery assembly of claim 16, the battery assembly further comprising:
a cell assembly positioned within the housing, the cell assembly comprising:
the plurality of battery cells; and
a first collector plate and a second collector plate, wherein the plurality of battery cells are electrically coupled together by the first collector plate and the second collector plate;
wherein the plurality of battery cells is positioned between the first collector plate and the second collector plate;
a plurality of bushings positioned between the housing and the first collector plate; and
a second plurality of bushings positioned between the housing and second collector plate.
